(19) United States
(12) Patent Application Publication
(10) Pub. No.: US 2003/0076221 A1
(43) Pub. Date: Apr. 24, 2003

(54) Vehicle communication system

(76) Inventors: Susumu Akiyama, Kariya-City (JP); Tomoko Kodama, Kariya-City (JP); Mamoru Sawada, Yokkaichi-City (JP); Hideo Wakata, Nagoya-City (JP)

Correspondence Address: LAW OFFICES OF DAVID G. POSZ, 2000 L STREET, N.W., SUITE 200, WASHINGTON, DC, 20036, US

(21) Appl. No.: 10/272,832

(22) Filed: Oct. 18, 2002

(30) Foreign Application Priority Data
Oct. 19, 2001 (JP) 2001-322665
Mar. 29, 2002 (JP) 2002-95822
Apr. 25, 2002 (JP) 2002-124191
Aug. 2, 2002 (JP) 2002-226248

(51) Int. Cl. H04M 11/04

(52) U.S. Cl. 340/310.01; 340/425.5; 307/10.1

(57) ABSTRACT

An O₂ sensor, an intake air temperature sensor, an engine coolant temperature sensor, a knock sensor, an electronic fuel injection device, a VSC ECU, a transmission ECU and an engine ECT are connected to a power line to communicate with one another through the power line. The VSC ECU, transmission ECU and engine ECU are further connected to a communication line to communicate with one another through two systems of the power line and a communication line. This makes it possible to improve the reliability while decreasing the number of the lines.

### BACKGROUND OF THE INVENTION

1. Field of the Invention

The present invention relates to a vehicle communication system used for transmitting and receiving data between various electric devices mounted on a vehicle.

2. Description of the Related Art

Vehicles such as passenger cars have, in recent years, been furnished with abundant electronic gadgets, and the devices such as various sensors and actuators are now incorporating microcontrollers making it possible to effect the communication between the ECUs (electronic control units) and the devices by using digital data. To cope with the needs in the market, such as improved fuel efficiency, zero emission, and easy-to-operate performance, the vehicle as a whole has been automated to a high degree, so as to be finely controlled, but needing an increased number of devices.

With the conventional devices in which the ECUs and the devices are connected through dedicated lines in a one-to-one manner, however, the number of the communication lines increases with an increase in the number of the devices, fuel efficiency is deteriorated as the weight increases, an increased space is required for installation, and workability for assembling is worsened. Besides, an increase in the number of the communication lines is accompanied by an increase in the chances of breakage of the communication lines and malfunctioning due to poor contact, deteriorating the reliability of the vehicle.

In order to solve the above-mentioned problems, therefore, a method has been realized according to which the number of lines is decreased relying upon the multiplex communication by using communication lines laid out in the form of a bus. There has further been contrived a method (so-called power line-superposed communication) which executes communication by superposing the signals on the power lines by further developing the above method. The communication method using the power lines may be one of the effective means for decreasing the number of the lines.

When the communication method employing the power lines is applied to a vehicle, however, the power lines are affected by noise from the exterior of the vehicle since the power lines have been laid out over the whole vehicle, and are further affected by noise, accompanying the operation of the devices, because the power lines are feeding the operational electric power to the devices and to the actuators such as motors, lamps and the like.

An ECU is usually provided for each of the functional units such as the engine, automatic transmission, brakes, etc. In recent years, ECUs have been so designed as to work in cooperation with one another to control the whole vehicle. Therefore, interruption of communication among the ECUs due to noise could cause a serious hindrance to operating the vehicle and, hence, it is becoming more important to maintain reliability of the communication between the ECUs.

In vehicles and, particularly, in automobiles, the number of various electric devices such as control devices, information equipment, audio devices, etc. that are mounted, is on the increase, and it is becoming necessary to link the operations or to share the data among the electric devices.

So far, therefore, attempts have been made to build up a so-called car-mounted network (car-mounted LAN) by incorporating data communication circuits in the devices and connecting them together through a communication line so that the data can be exchanged among the electric devices of which the operations must be linked together or of which the data must be shared among a variety of electric devices mounted on the vehicle.

The car-mounted network usually divides the electric devices mounted on the vehicle depending upon the functions and systems, such as the control system for connecting the control devices that control the engine, automatic transmission, brakes, etc., and the body system for connecting the control devices that control locking/unlocking the doors, air-conditioning system, etc., and is built up for each of the divided groups.

However, the car-mounted network fails to conduct the data communication normally not only when the communication lines are broken and short-circuited but also when noise has entered the network.

So far, therefore, a system has been proposed as disclosed in, for example, Japanese Patent No. 2922004 according to which the communication lines are laid out in two systems and, among the devices constituting the network, the important devices are provided with a normal communication circuit for effecting the communication through a first communication line connected to all of the devices and with a spare communication circuit for effecting the communication through a second communication line connected to the important devices only, wherein in case the first communication lines or the normal communication circuit has failed, a monitoring device for monitoring this state changes the communication circuit used for the communication by the important devices over to the spare communication circuit to continue the data communication.

Namely, in the above proposed system, in case the data communication utilizing the first communication line fails, the monitoring device instructs the important devices to effect the data communication by using the spare communication circuit, and relays the data between the second communication line connected to the spare communication circuit and the first communication line enabling the data communication to be effected in a normal way among the important devices.

However, the above proposed system is the one of a so-called centralized monitoring type in which only the important portions of the network are supported by a double system and the communication line used for the data communication is changed over under the control of the monitoring device. Therefore, if the monitoring device itself becomes defective or if the connection between the monitoring devices and the communication lines is broken, then, the communication line used for the data communication is not changed from the first communication line over to the second communication line when the data communication, utilizing the first communication line, has failed and the backup communication, utilizing the second communication line, is no longer realized.

In the above proposed system, further, once the monitoring device detects even a temporarily occurring failure of communication on the first communication line due to the entry of noise, etc., the communication line used for the data communication line is changed from the first communication line over to the second communication line but, thereafter, the data communication using the first communication line is not automatically recovered. Therefore, if the data communication fails on the second communication line after the communication line has been changed over, the communication of data cannot be executed among the devices even though data could really be communicated by using the first communication line.

In the vehicle drive system constituted by the engine, transmission, etc., further, a network is built up by connecting together the electric devices (concretely speaking, engine controller, transmission controller, etc.) used for the control operation through a communication line, and the electric devices execute the data communication through the network so as to share the data necessary for the control operation and to control the whole drive system efficiently and in an optimum manner.

As for the transmission among the devices constituting the vehicle drive system, it can be contrived to separate the operation unit (shift lever, etc.) for changing over the shift position from the mechanism for changing over the shift position of the transmission that have hitherto been coupled together directly or through a linking mechanism (so-called shift-by-wire system).

Namely, a shift position instruction detector is provided on the side of the operation unit, such as the shift lever or the like, to detect a shift position instruction input by the operation of the driver, and a shift position controller is provided on the side of the transmission to change over the shift position of the transmission depending upon the shift position instruction detected by the shift position instruction detector, thereby to constitute the operation unit provided in the compartment separately from the transmission provided outside the compartment.

This improves the workability in assembling the transmission and the operation unit on the vehicle, and enhances the freedom for arranging the transmission on the vehicle.

In order to realize the shift-by-wire system, it is necessary to arrange a signal line for transmitting the shift position instruction detected by the shift position instruction detector to the shift position controller.

Here, if the shift position controller is so constituted as to change over the shift position of the transmission relying only upon the shift position instruction detected by the shift position instruction detection means, the shift position of the transmission is changed over even when the operation unit is erroneously operated by the driver while the vehicle is traveling. It is therefore desired that the shift position controller is so constituted as to receive detection signals from the sensors that detect the operating conditions of the vehicle (e.g., vehicle speed, operating condition of the brake device, etc.) and prevents the shift position change-over caused by the erroneous operation of the operation unit by the driver. For this purpose, another signal line is necessary for sending the detection signals from the sensors that detect the operating conditions of the vehicle to the shift position controller.

In vehicles and, particularly, in automobiles, however, many electric devices are mounted for controlling the vehicle to meet the needs of the market, such as fuel efficiency, improving the operability and improving the easy-to-use performance, and many signal lines are arranged to electrically connect these devices. It is, therefore, difficult to newly add the signal lines for realizing the shift-by-wire system. Besides, an increase in the number of the signal lines arranged in the vehicle results in an increased chance of developing malfunctions due to breakage of signal lines and poor contacts and, hence, a decrease in the reliability of the vehicle. In realizing the shift-by-wire system, therefore, an additional arrangement of the signal lines on the vehicle involves a problem.

To realize the shift-by-wire system, therefore, it is desired that the shift position instruction detector on the side of the operation unit and the shift position controller on the side of the transmission are connected to the network of the above-mentioned vehicle drive system, so that the shift position instruction detected by the shift position instruction detector and the detection signals representing the operating conditions of the vehicle are transmitted to the shift position controller through the network of the vehicle drive system.

However, the shift-by-wire system has heretofore been so designed as to separate the transmission and the operation unit, that are mechanically connected together directly or through a link mechanism, from each other. Therefore, a simple connection of the shift position instruction detector on the side of the operation unit and the shift position controller on the side of the transmission to the network of the vehicle drive system, permits the occurrence of a defective change-over of the shift position which could not have occurred in a conventional vehicle.

Namely, in a conventional vehicle, the operation of the shift lever by the driver is mechanically transmitted to the transmission. In a vehicle mounting an automatic transmission, for example, even when the transmission controller becomes defective, it is possible to change the shift position of the automatic transmission over to a shift position such as drive “D” or reverse “R”, and the vehicle can be moved in a side lane. With the shift-by-wire system, however, it is not possible to move the vehicle even in a side lane if the transmission system fails to transmit the shift position instruction between the shift position instruction detector and the shift position controller.

In realizing the shift-by-wire system, therefore, a simple connection of the shift position instruction detector and the shift position controller to the network of the vehicle drive system is not enough to maintain safety if the network has failed, and the reliability of the vehicle becomes inferior to that of a conventional vehicle.

### SUMMARY OF THE INVENTION

The present invention was accomplished in view of the above-mentioned problems, and its first object is to use the power lines for the communication to decrease the number of lines and to improve the reliability in a vehicle communication system in which a plurality of electric devices mounted on a vehicle are connected together through communication lines, its second object is to prevent such an occurrence that the data (particularly, important data) are no longer exchanged among the devices due to a failure in the data transmission passage in the vehicle communication system without the need of employing a centralized monitoring device for monitoring the communication state, and its third object is to improve the safety and reliability of the vehicle realizing the shift-by-wire system in the vehicle communication system which belongs to the vehicle drive system.

According to a first aspect for accomplishing the above-mentioned first object of the invention, a vehicle communication system described in claim 1 is equipped with a plurality of electric devices connected to a first communication line which feeds the electric power to the electric devices. Some of the electric devices are further connected, as special electric devices, to a second communication line and are allowed to effect communication through the two systems of the first communication line and the second communication line.

Namely, the first communication line is used for the data communication among the electric devices and among the special electric devices, and is further used as a power line for feeding electric power to the electric devices and to the special electric devices, making it possible to decrease the number of the lines. Among the special electric devices, further, the data are communicated through two systems of the first communication line and the second communication line, contributing to improving the reliability of communication among the special electric devices. That is, the reliability is improved while decreasing the number of lines in the vehicle communication system.

The special electric devices may be, as described in claim 2, those capable of executing at least either a processing for transmitting instruction data to the electric devices or a processing for receiving and using the data of results from the electric devices.

The special electric devices may be, for example, ECUs. Such special electric devices, in many cases, play important roles in the vehicle communication system, and it is meaningful to support the communication among them by two systems.

Further, the first communication line is connected to more devices than the devices which are connected to the second communication line. When considered in terms of the amount of transmission and reception per unit, therefore, it is difficult to transmit and receive more data by using the first communication line than the data transmitted and received by using the second communication line.

Therefore, the data communicated among the special electric devices by using the first communication line may be the same as the data communicated by using the second communication line. As described in claim 3, however, the communication among the special electric devices, using the first communication line, may deal with predetermined important data only.

This makes it possible to lower the speed of communication through the first communication line to improve reliability. The important data may include data which are at least necessary for the functioning of the vehicle communication system as well as data related to safety.

When the data are communicated by using two systems of communication lines, the data may be selected by a method described in, for example, claim 4. Namely, the special electric devices judge the reliability of data transmitted through the second communication line, use the data when the reliability is higher than a predetermined reference, and use the data transmitted through the first communication line instead of using the data transmitted through the second communication line when its reliability is lower than the predetermined reference and when the data of the same content are transmitted even through the first communication line. The method of judging the reliability and the predetermined reference will be described later.

By avoiding the use of data of which the reliability is lower than the predetermined reference, it is possible to decrease the probability of malfunction of the vehicle communication system and to improve the reliability of the vehicle communication system.

When the reliability of data transmitted through the second communication line does not meet the predetermined reference, the data transmitted through the first communication line may be used unconditionally. When the reliability of data transmitted through the second communication line fails to meet the predetermined reference, however, the data transmitted through both the first communication line and the second communication line may be judged for their reliability as described in claim 5, and the data having a higher reliability may be used.

Then, it is possible to decrease the probability of malfunction of the vehicle communication system and to improve the reliability of the vehicle communication system.

The special electric devices may chiefly use the data transmitted through the second communication line. As described in claim 6, however, the special electric devices that have received data transmitted through both the first communication line and the second communication line, may judge the reliability of the data, and may use the data having higher reliability.

Then, it is allowed to decrease the probability of a malfunction of the vehicle communication system and to improve the reliability of the vehicle communication system.

When the data transmitted through the two communication lines are both determined to have low reliability, then, the special electric devices may use data stored in advance or the data transmitted in the past instead of using the data having low reliability as described in, for example, claim 7.

Then, even when the data transmitted through the communication lines of two systems both have low reliability, the data stored in advance or the data transmitted in the past are used to maintain the minimum of functions of the vehicle communication system. This leads to an improvement in the reliability of the vehicle communication system.

As described in claim 8, further, the special electric devices may instruct the source of transmitting the data to transmit the data again. This makes it possible to improve the reliability of the vehicle communication system except when the data are needed readily.

As a method of judging the reliability of the received data, the special electric devices may, as described in, for example, claim 9, check at least any one of (or, preferably, all of) a data error detection code, a period for receiving the data, a continuity of data content from the data received in the past and a validity of data content.

Namely, it is considered that the received data have low reliability when the data are judged to be incorrect by using an error detection code such as checksum or CRC, when the period for receiving the data is different from the normal period, when the data received this time is not continuously changing from the data received in the past or when the data value does not lie within a normal range. Upon checking them, therefore, the reliability of the received data can be judged. The above-mentioned predetermined reference is set by taking into consideration a limit with which the function of the vehicle communication system can be safely realized and a limit upon which the user such as the driver can perceive the range of normal operation.

When the data received through the communication lines are faulty as a result of judging the reliability, the special electric devices may notify this fact to an external unit (e.g., to a passenger such as the driver or to an administrator who is not on board) as described in claim 10. All faulty conditions may be notified or only serious fault conditions only (e.g., when the movement of the vehicle is hindered because the faulty data is important data, when the received data have low reliability continuously, or when the data to be received are not really received) may be notified. The notifying method may be, for example, turning an alarm lamp on, producing an alarm sound or presenting a display on a liquid crystal display.

Then, if the data received through the communication lines are faulty, the driver is urged to check and repair the communication lines and devices to prevent the function of the vehicle communication system from breaking down due to the occurrence of defects in the communication lines of the two systems and enabling the faulty portion to be located.

Next, in order to accomplish the above-mentioned second object, the present inventors have completed the invention of three of aspects, i.e., a vehicle communication system (second aspect) described in claims 11 to 19, a vehicle communication system (third aspect) described in claims 20 to 28, and a vehicle communication system (fourth aspect), described in claims 29 to 33.

In the vehicle communication system according to the second aspect of the invention as described in claim 11, the electric devices mounted on the vehicle are provided with a plurality of communication means for transmitting and receiving the same data using different communication lines to build up the network by using the communication lines in the form of two or more systems.

According to the second aspect of the invention, the plurality of communication means provided for the electric devices for building up the network of the multiplex system, transmit and receive the same data in parallel, and the selection means in the electric devices selects normal data out of the data received by the plurality of communication means.

Namely, the vehicle communication system according to the second aspect is constituted as a so-called distributed monitoring type system in which the electric devices transmit and receive one data using a plurality of communication lines, and normal data is selected out of the plurality of data obtained through the communication lines on the side of the electric device that receives the data. Unlike the above-mentioned conventional system of the centralized monitoring type, therefore, there is no need to use a monitoring device for monitoring the data communication on the communication line used chiefly for the data communication, and the backup communication is realized if the communication line fails.

In the vehicle communication system according to the second aspect of the invention, further, even when the communication line has become no longer capable of normally communicating the data due to the infiltration of noise, the selection means selects the normally received data as the received data and improves the reliability of data communication as compared to the above-mentioned conventional system of the centralized monitoring type.

In the vehicle communication system according to the second aspect of the invention, further, the communication lines used for the data communication are not simply used in a plural number, but communication means connected to one of the plurality of communication lines is one which communicates the data at a slower speed than other communication means in each electric device; i.e., the plurality of communication lines include one communication line for communication at a slow speed. Therefore, the data communication through the network constituted by the communication line of slow speed communication features a reliability higher than the network constituted by other communication lines.

In the vehicle communication system according to the second aspect of the invention, therefore, the data received through communication means which is usually capable of communicating data at high speeds are selected as data transmitted from the other electric devices by using the selection means in the electric devices, and the data received through communication means of a slow speed are selected as data transmitted from the other electric devices only when the data communication has failed in the communication means capable of communicating the data at high speeds. Namely, according to the second aspect of the invention, reliability in the data communication is improved without decreasing the speed of transmitting the data in the normal operation.

According to the second aspect of the invention, however, the data flows at a speed slower than the speed of the other communication lines in one of the plurality of communication lines that constitute the networks in order to maintain reliability in the data communication. Therefore, the maximum data quantity transmitted through the network of the slow speed is smaller than the maximum data quantity transmitted using other networks.

Therefore, when the second aspect of the invention is applied to a network that must transmit and receive a large amount of data among a plurality of electric devices as in the network of the control system, the slow-speed communication means provided in the electric devices transmits and receives predetermined important data only among the data transmitted and received by other communication means, and the selection means selects the normal and important data out of the important data obtained by the plurality of communication means inclusive of the low-speed communication means when the important data are being received.

Normally, therefore, the vehicle can be controlled at a high speed and highly precisely by using a large amount of data transmitted and received through communication means capable of communicating the data at high speeds, and can be controlled by using the important data only that are transmitted and received through the low-speed communication means only when the data communication has failed in the communication means that is capable of communicating the data at high speeds.

When the data transmitted and received by the low-speed communication means are limited to important data, the important data may simply be part of the data transmitted and received by other communication means different from the low-speed communication means, but may be the drive data for directly driving the object of control transmitted from the electric devices through the low-speed communication means to the object of control controlled by other electric devices.

When the vehicle communication system according to the second aspect of the invention is constituted as described above, one of the electric devices constituting the system may include a first control unit described in claim 13 or a second control unit described in claim 14.

That is, in the first control unit described in claim 13, operation means generates the data for driving an object that is to be controlled, and drive means drives the object of control according to the drive data generated by the operation means. When the operation means has failed, however, the drive data change-over means changes the drive data input to the drive means from the drive data generated by the operation means over to the drive data (drive data transmitted as important data from the low-speed communication means of other electric devices) received by the drive data-receiving means.

In the second control unit described in claim 14, further, operation means generates the drive data for driving an object to be controlled based upon the data obtained from the other electric devices through any one of the plurality of communication means inclusive of the low-speed communication means, and drive means drives the object of control according to the drive data that are operated. When the operation means has failed, however, the drive data change-over means changes the drive data input to the drive means from the drive data operated by the operation means over to the drive data (drive data transmitted as important data from the low-speed communication means of other electric devices) received by the drive data-receiving means.

According to the vehicle communication system described in claim 13 or claim 14, therefore, the object of control can be operated based on the important data transmitted and received through the communication line capable of communicating the data at a low speed not only when the data communication has failed in the communication means capable of communicating the data at high speeds but also when the operation means for operating the drive data for driving the object to be controlled by the controller (first controller or second controller) of the vehicle has failed (e.g., even when a microcontroller constituting the operation means has failed). Therefore, the vehicle control system is prevented from being erroneously controlled, and it is possible to improve safety while the vehicle is traveling and to improve reliability in the vehicle control system.

According to the second aspect of the invention (claims 11 to 14), the communication line which the low-speed communication means uses for the data communication may be a signal line dedicated to the data communication. However, this results in an increase in the number of the signal lines (communication lines) arranged in the vehicle. More desirably, therefore, use is made of the power line that has been arranged already in the vehicle for feeding the electric power from the car-mounted power source to the electric devices as described in claim 15.

In building up the low-speed network relying upon the low-speed communication means as described above, there is no need of arranging the dedicated communication lines, and the vehicle communication system according to the second aspect of the invention can be realized at a further decreased cost.

When the low-speed network is built up by using the power line as described above, it is desired as described in claim 16 that as one of the electric devices, there is provided a power source monitoring device which monitors the state of feeding the electric power from the car-mounted power source to the car-mounted equipment inclusive of electric devices, and transmits the monitored results to the other electric devices through the plurality of communication means inclusive of the low-speed communication means.

Voltage fluctuation occurs on the power line depending upon the operating conditions of the car-mounted devices (motors, etc.) that are supplied with the electric power through the power line and, besides, high-frequency noise generated by the car-mounted devices is superposed thereon. Therefore, if the state of being supplied with the electric power is monitored by the power source monitoring device and the data thereof are transmitted to other electric devices through the network, it is possible to detect the state of data communication on the side of the electric devices by using the power line and to avoid the use of the data received through the low-speed communication means in case the data communication has a low reliability. This makes it possible to further improve the reliability of data communication in the whole vehicle communication system.

Next, in the vehicle communication system according to the second aspect of the invention (claims 11 to 16), three or more kinds of networks may be built by providing the electric devices with three or more communication means inclusive of the low-speed communication means. However, an increase in the number of the networks is accompanied by an increase in the cost of the system. Therefore, the electric devices may be provided with one high-speed communication means as another communication means which is different from the low-speed communication means thereby to build up two kinds of networks.

When the network for data communication is built as two systems as described in claim 17, selection means provided in the electric devices judges whether the data communication by the high-speed communication means is normal, and when the data communication by the high-speed communication means is normal, selects the data received through the high-speed communication means as data transmitted from the other electric devices, and when the data communication by the high-speed communication means has failed, selects the data received through the low-speed communication means as data transmitted from the other electric devices.

Thus, when normally communicated as described above, the data received through the communication means capable of communicating the data at high speeds are utilized as data transmitted from the other electric devices. Only when the data communication by the communication means has failed, are the data received through the low-speed communication means used as data transmitted from the other electric devices. Thus, reliability in the data communication is improved without lowering the speed of transmitting the data of normal operation.

When the selection means judges the normal/faulty condition of data communication of the high-speed communication means, the hardware fault (i.e., breakage of a line, a short-circuit, etc.) in the communication lines may be detected relying upon the potential of the communication lines to which the high-speed communication means is connected or upon the signals (data) flowing into the communication lines. Or, the data received through the high-speed communication means may be checked to detect a faulty condition in the received data.

In checking the received data, further, a checking signal may be fed to the communication lines at regular intervals, and the selection means may judge the reception of data to be faulty if the regular signals are not received for more than a predetermined period of time. Or, a particular data for checking may be regularly sent from the electric devices. When the data is not recovered by the selection means from the received signals for more than a predetermined period of time, the reception of data may be judged to be faulty. Or, the data imparted with a checking code (e.g., a CRC) may be transmitted from the electric devices, and the selection means may judge the faulty condition in the received data by using the checking code. Or, these checks may be effected in combination.

When the network for data communication is formed in two systems as described above, the high-speed communication means transmits and receives data the same as the data transmitted and received through the low-speed communication means a plural number of times in a time-dividing manner as described in claim 18, and the selection means takes a majority of the data received a plural number of times through the high-speed communication means and of the data received through the low-speed communication means in order to select a normally received data out of the plurality of data that are received.

That is, a faulty data communication that is most likely to occur in the vehicle stems from the loss of some data due to a disturbance. As described in claim 18, therefore, the same data are transmitted and received a plural number of times through the high-speed communication means, and a majority is taken from the data that are thus received and the data received through the low-speed communication means in order to select a normally received data thereby to improve reliability in the data communication. This technology, however, requires an extended period of time for the transmission and reception of data, and is better employed for the network of the body system which does not require high-speed communication rather than being employed for the network of the control system which requires high-speed communication.

In realizing the vehicle communication system according to the second aspect of the invention (claims 11 to 16), for example, when three networks are built up by providing the electric devices with three communication means inclusive of the low-speed communication means, the majority may be taken from the three data received through the communication means to obtain a correctly received data.

In the vehicle communication system according to the second aspect of the invention (claims 11 to 18), the electric devices constituting the communication system are provided with the plurality of communication means inclusive of the low-speed communication means. However, when the path for inputting the received data to any communication means has failed, it becomes impossible to transmit the data to the other electric devices through this communication means.

In this case, therefore, failure in the path for inputting the transmission data to the communication means is judged on the side of the electric devices and any failure that has occurred is notified to the other electric devices. This prevents the other electric devices from executing unnecessary receiving operations for receiving the data from the communication means of which the path for inputting the transmission data has failed.

Therefore, in the vehicle communication system according to the second aspect of the invention (claims 11 to 18) as described in claim 19, it is desired that at least one of (or preferably all of) the electric devices includes:

failure-in-the-path judging means for letting the plurality of communication means inclusive of the low-speed communication means receive the transmission data input to the other electric devices to judge whether the transmission data are normal, and for so judging, if the transmission of data has failed, that the path for inputting the transmission data to the failed communication means has failed; and

failure-in-the-path notifying means which, when it is judged by the failure-in-the-path judging means that the path for inputting the transmission data to any communication means has failed, sends the data expressing this fact as transmission data to the communication means of which the input path is normal, and notifies this fact to the other electric devices through the normal communication means.

Next, as described in claim 20, the vehicle communication system according to a third aspect of the invention is provided with a plurality of car-mounted networks separately depending upon the functions and systems of the electric devices so as to transmit and receive the data among the electric devices by providing the electric devices mounted on the vehicle with first communication means for communicating the data through a communication line dedicated to the network.

In the vehicle communication system according to the third aspect of the invention, the electric devices constituting the car-mounted networks are provided with second communication means for executing the data communication through the backup communication line commonly used by the car-mounted networks arranged in the vehicle, predetermined important data are transmitted and received by the electric devices through the second communication means (so-called backup communication) among the data which are transmitted and received among the other electric devices through the first communication means, and the selection means selects normal and important data out of the important data obtained through the first communication means and the second communication means.

Namely, the vehicle communication system according to the third aspect of the invention is the system of the distributed monitoring type in which the electric devices transmit and receive the important data through the communication lines of two systems, and the electric devices for receiving the important data select a normal and important data out of the important data obtained through the first communication means and the second communication means.

Therefore, like the system of the first invention, the vehicle communication system according to the third aspect of the invention, too, needs no monitoring device for monitoring the data communication through the communication line that is chiefly used for the data communication unlike the above-mentioned conventional system of the centralized monitoring type, the backup communication is realized if the communication line has failed, and reliability in the data communication is improved as compared to the conventional system of the centralized monitoring type.

That is, according to the third aspect of the invention, important data are transmitted and received in a double manner (backup communication) through the backup communication line commonly used by the car-mounted networks among the data transmitted and received through the plurality of car-mounted networks built up depending upon the functions and systems of the vehicle.

Therefore, even in case the data communication has failed in any one of the car-mounted networks, the important data transmitted and received through the car-mounted networks are reliably transmitted to the electric devices that need important data, improving reliability in the data communication.

According to the second aspect of the invention, in particular, the backup communication line is commonly used by the plurality of car-mounted networks built up in a vehicle. As compared to when the backup communication line is provided for each of the car-mounted networks, therefore, the number of the communication lines arranged in the vehicle can be decreased, and the cost can be decreased, too.

Here, the communication line dedicated to the data communication may be used as the backup communication line. In vehicles, however, the power line for feeding the electric power has been connected to the electric devices. As described in claim 21, therefore, it is desired to use, as the backup communication line, the power line arranged in the vehicle so as to feed the electric power from the car-mounted power source to the electric devices. Then, there is no need of separately arranging the backup communication line dedicated to the communication, and the cost can be further decreased.

When the power source line is used as the backup communication line, it is desired, as described in claim 22, to provide, as one of the electric devices, a power source-monitoring device which monitors the state of feeding the electric power from the car-mounted power source to the car-mounted equipment inclusive of electric devices, and transmits the monitored results, as important data, to the other electric devices through the first communication means and the second communication means.

This makes it possible to obtain the same effects as those of claim 16 of the second aspect of the invention. According to the third aspect of the invention, however, the plurality of car-mounted networks use the common backup communication line. In order that the monitored results are transmitted from the power source monitoring device to the electric devices of all of the car-mounted networks, therefore, the power source monitoring device is provided with communication means (first communication means) for the car-mounted networks or is provided with a device (e.g., driver agent ECU of an embodiment appearing later) having a gateway function for transmitting and receiving important data such as the monitored results among the car-mounted networks. The monitored results must be transmitted from the power source monitoring device to the other electric devices inclusive of the device having the gateway function by using the first communication means of any car-mounted network.

The backup communication line is to transmit important data transmitted through the car-mounted networks. If the communication frequently fails in the backup network built up by using the backup communication line, reliability in the data communication decreases. It is therefore desired that the data communication through the backup network is more reliable than the data communication through the other car-mounted networks. For this purpose as described in claim 23, it is desired that the second communication means for executing the backup communication transmits and receives the important data at a speed slower than that of the first communication means.

According to the third aspect of the invention, the important data to be transmitted through the car-mounted networks are transmitted by using the backup communication line. The important data may simply be those important data among the data transmitted through the car-mounted networks, or may be the drive data for directly driving the object of control in addition to the above data as in claims 13 and 14 according to the second aspect of the invention.

When the vehicle communication system according to the third aspect of the invention is constituted as described above, one of the electric devices constituting the system may include a first control unit described in claim 24 or a second control unit described in claim 25.

That is, in the first control unit described in claim 24, operation means operates the data for driving an object that is to be controlled, and drive means drives the object to be controlled according to the drive data operated by the operation means. When the operation means has failed, however, the drive data change-over means changes the drive data input to the drive means from the drive data operated by the operation means over to the drive data (transmitted from the second communication means of other electric devices through the backup communication line) received by the drive data-receiving means.

In the second control unit described in claim 25, further, operation means operates the data for driving an object that is to be controlled based upon the data obtained from the other electric devices through the first communication means or the second communication means, and drive means drives the object to be controlled according to the drive data that are operated. When the operation means has failed, however, the drive data change-over means changes the drive data input to the drive means from the drive data operated by the operation means over to the drive data received by the drive data-receiving means (changes the data for driving the object to be controlled transmitted from the second communication means of other electric devices through the backup communication line over to the drive data transmitted through the backup communication line).

According to the vehicle communication system described in claim 24 or claim 25, therefore, the object of control can be operated based on the important data transmitted and received through the backup communication line not only when the data communication by the first communication means has failed in any car-mounted network but also when the operation means for operating the data for driving the object to be controlled by the controller (first controller or second controller) of the vehicle has failed (e.g., even when a microcontroller constituting the operation means has failed). Therefore, the vehicle control system is prevented from being erroneously controlled, and it is possible to improve safety while the vehicle is traveling and to improve reliability in the vehicle control system.

Next, in the vehicle communication system according to the third aspect of the invention, the backup communication line is commonly used by the plurality of car-mounted networks to transmit the important data in two systems. In this case, the received data may be selected by selection means described in claim 26 or selection means described in claim 27.

Namely, in the vehicle communication system described in claim 26, the selection means provided in the electric devices constituting the car-mounted networks judges whether the data communication through the first communication means is normal, selects the data received through the first communication means as data transmitted from the other electric devices when the data communication is normal, and selects the data received through the second communication means as data transmitted from the other electric devices when the data communication by the first communication means has failed. Therefore, the vehicle communication system described in claim 26 offers the same effects as those of claim 17 of the second aspect of the invention.

In the vehicle communication system described in claim 27, further, the first communication means is so constituted as to transmit and receive, a plural number of times, the important data transmitted and received by the second communication means, and the selection means takes a majority of the important data received by the first communication means a plural number of times and of the important data received by the second communication means, thereby to select a normally received data out of the plurality of important data. The vehicle communication system described in claim 27 offers the same effects as those of claim 18 of the second aspect of the invention.

In the vehicle communication system according to the third aspect of the invention (claims 20 to 27), the electric devices constituting the system are all provided with the first communication means corresponding to the car-mounted networks to which the electric devices belong and with the second communication means used in common by the car-mounted networks. In the vehicle communication system according to the third aspect of the invention, too, therefore, it is desired that any failure that has occurred in the path for inputting the transmission data to any one of the communication means is notified to the other electric devices.

Therefore, as described in claim 28 (or, in other words, in the same manner as that of claim 19 of the second aspect of the invention), it is desired that at least one of (or preferably all of) the electric devices includes:

failure-in-the-path judging means for letting the first communication means and the second communication means receive the transmission data input to the other electric devices to judge whether the transmission data are normal, and for so judging, in case the transmission of data has failed, that the path for inputting the transmission data to the failed communication means has failed; and

failure-in-the-path notifying means which, when it is judged by the failure-in-the-path judging means that the path for inputting the transmission data to any communication means has failed, sends the data expressing this fact as transmission data to the communication means of which the input path is normal, and notifies this fact to the other electric devices through the normal communication means.

Next, as described in claim 29, in the vehicle communication system according to a fourth aspect of the invention, the electric devices mounted on the vehicle are provided with communication means for executing the data communication through the communication lines arranged in the vehicle to transmit and receive the data among the electric devices, and wherein the communication means is so constituted as to transmit and receive the same data a plural number of time through the communication lines, and the electric devices are provided with selection means for selecting a normally received data out of the plurality of data obtained after having been transmitted and received the plural number of times through the communication means.

Namely, in the vehicle communication system according to the fourth aspect of the invention, the networks are not formed in a multiplex of systems of two or more systems by using the plurality of data transmission lines, unlike those of the second and third aspects of the invention, but the same data are transmitted and received a plural number of times (or, in other words, a multiplex communication) by using a single communication line to lower the probability of failure in the data communication when data is transmitted, thereby to improve reliability in the data communication.

According to the vehicle communication system of the fourth aspect of the invention, therefore, in case the communication line is broken and is short-circuited, the important data are not backup-transmitted by using other communication lines (inclusive of the power line). If noise has temporarily occurred (in automobiles, noise often occurs temporarily due to starting or stopping of actuators such as electric motors), however, the data are normally transmitted through the data communication conducted a plural number of times. Besides, only one communication line is required as in the prior art. Therefore, the vehicle communication system is cheap to realize compared to those of the second and third aspects.

The vehicle communication system according to the fourth aspect of the invention is of a distributed monitoring type in which the electric devices connected to the network select a normally received data out of the data obtained through the plural number of times of data communication. As in systems of the second and third aspects of the invention, therefore, the system can be cheaply realized as compared with the conventional systems since there is no need to separately connect the monitoring device to the communication line that is done in the above-mentioned conventional system of the centralized monitoring type.

In the vehicle communication system according to the fourth aspect of the invention, the selection means selects normally received data out of the plurality of data received by the receiving operation of the communication means effected a plural number of times. When the data are selected, it may be judged whether the plurality of data received through the communication means are normal by using a CRC. As described in claim 30, for example, the communication means may be so constituted as to transmit and receive the same data three or more times through the communication line. Then, the selection means takes a majority from three or more data received by the communication means to select the normally received data. Namely, by constituting the vehicle communication system according to the fourth aspect of the invention in a manner as described in claim 30, it is possible to select a normally received data based on a simple operation of comparison.

The communication means transmits and receives the same data a plural number of times. When the same data are thus transmitted and received a plural number of times as described in claim 31, these data may be transmitted and received a plural number of times by a time-division multiplex communication based upon the TDMA (time division multiple access). Or, the same data may be transmitted and received a plural number of times by a simultaneous multiplex communication based upon the FDMA (frequency division multiple access) or the CDMA (code division multiple access).

As the communication line for constituting the vehicle communication system according to the fourth aspect of the invention, further, the communication line may be the one dedicated to communication. From the standpoint of decreasing the number of the signal lines arranged in the vehicle and of simplifying the wiring operation, further, it is possible, as described in claim 32, to use, as the communication line, the power source line arranged in the vehicle for feeding the electric power from the car-mounted power source to the electric devices.

According to the fourth aspect of the invention, the same data is transmitted to one communication line (inclusive of the power line) a plural number of times, and the electric devices select a normally received data out of the plurality of data received by the communication. Therefore, an extended period of time is required for transmitting and receiving a data since the received data are judged and selected.

It is therefore desired that the vehicle communication system according to the fourth aspect of the invention is applied to a car-mounted network which does not require high-speed communication. As described in, for example, claim 33, when the electric devices are the control systems comprising sensors for detecting the state of the vehicle, actuators for driving the object to be controlled and controllers for driving the actuators by operating the control quantities of the objects to be controlled based upon the detection signals from the sensors, then, the communication means of the invention may be provided for each of the sensors, actuators and controllers to thereby constitute a communication system for transmitting the detection data from the sensors to the controllers and for transmitting the drive data from the controllers to the actuators.

In the communication system of the vehicle drive system according to a fifth aspect of the invention described in claim 34 which is for accomplishing the third object described above, the communication lines of two systems including a first communication line and a second communication line are used for communicating the data. To each of the communication lines are connected various electric devices of the vehicle drive system including a shift position instruction detector unit provided in the operation unit for instructing the shift position of the transmission by the external operation and a shift position control unit which sets an optimum shift position adapted to the vehicle based upon the shift position instruction detected by the shift position instruction detector means and upon the operating conditions of the vehicle, and changes the shift position of the transmission over to the optimum shift position.

The shift position instruction detector transmits the shift position instruction input from the operation unit to the other electric devices such as the shift position control unit and the like through the communication lines of the above two systems (first communication line and second communication line).

According to the fifth aspect of the invention, therefore, even when the shift position instruction is not transmitted from the shift position instruction detector means to the shift position control unit by using the first communication line due to the breakage or poor contact of the first communication line or due to a fault in the communication means in the electric devices connected to the first communication line, it is possible to transmit the shift position instruction from the shift position instruction detector means to the shift position control unit through the second communication line.

Therefore, the fifth aspect of the invention enhances reliability of the shift-by-wire system constituted by the shift position instruction detector unit and the shift position control unit and maintains the safety of the vehicle by preventing such an occurrence that the shift position control unit cannot obtain a shift position instruction from the shift position instruction detector unit due to a fault in the network constituted by the first communication line or the second communication line and that it is not allowed to change over the shift position of the transmission.

According to the fifth aspect of the invention, further, the electric devices of the vehicle drive system are connected through the communication lines (networks) of two systems. Therefore, reliability is improved not only in transmitting the shift position instruction from the shift position instruction detector unit to the shift position control unit but also in transmitting the shift position instruction from the shift position instruction detector unit to the other electric devices (e.g., to the other control devices of the vehicle drive system, such as an engine controller and a transmission controller). It is further allowed to transmit and receive various kinds of data necessary for controlling the vehicle drive system among the other electric devices (inclusive of the shift position controller) except the shift position instruction detector unit by using the communication lines (networks) of two systems.

According to the fifth aspect of the invention, therefore, it is made possible to improve the reliability of not only the control operation for simply changing over the shift position of the transmission but also of the vehicle drive system as a whole and, hence, to improve the reliability of the vehicle to maintain safety when the vehicle is traveling.

As described above, the vehicle drive system as a whole exhibits improved reliability. Therefore, when the data communication is effected by utilizing the communication lines (networks) of two systems even among the other electric devices (inclusive of the shift position controller) except the shift position instruction detector unit, the electric devices may transmit all transmission data to the other electric devices using the communication lines (networks) of two systems. For this purpose, the electric devices must be provided with communication means capable of transmitting and receiving the same data at the same communication speed.

However, the communication system of the vehicle drive system must transmit and receive the data at high speeds for controlling the engine and the like. If the electric devices are all provided with communication means capable of communicating the data at high speeds in two systems, however, the cost of the system as a whole becomes high.

When the data are communicated among the other electric devices (inclusive of the shift position controller) except the shift position instruction detector by using the communication lines (networks) of two systems in order to improve the reliability of the vehicle drive system as a whole, the second communication line is used for transmitting important data inclusive of the shift position instruction (or, in other words, used as a communication line for backup) as described in claim 35, and the electric devices except the shift position instruction detector unit transmit predetermined important data only among the data to be transmitted to the other electric devices by using the communication lines of two systems comprising the first communication line and the second communication line, and transmit the data other than the important data to the other electric devices using the first communication line only.

By so doing, the second communication line needs to transmit and receive only the important data including the shift position instruction. Therefore, it is possible to decrease the speed of communication through the second communication line to be lower than the speed of communication through the first communication line. As a result, the communication means provided for the electric devices for transmitting and receiving the important data can be realized at a lower price than the communication means connected to the first communication line for transmitting and receiving all data thus suppressing the cost of the system as a whole owing to an improved reliability of the communication system.

When the second communication line is used for the communication of the shift position instruction only or for the backup communication of the important data inclusive of the shift position instruction, the first communication line may be the one dedicated to data communication and the second communication line may be the power line arranged in the vehicle for feeding the electric power from the car-mounted power source to the electric devices as described in claim 36.

Namely, the power line permits noise to be easily superposed thereon and may not maintain reliability of communication if it is used for the data communication that requires a high speed of communication. When the second communication line is used for the communication of the shift position instruction only or for the backup communication of important data inclusive of the shift position instruction, however, it is possible to decrease the speed of communication to be lower than that of when the whole data are transmitted and received among the electric devices. Therefore, the power line can be used as the second communication line to a sufficient degree.

Then, in building up the communication system according to the fifth aspect of the invention, there is no need of newly arranging the communication line dedicated to the data communication as the second communication line, and the communication system of the invention is cheap to realize.

In the communication system according to the fifth aspect of the invention, when the data such as shift position instruction, which is to be transmitted through the communication lines of two systems comprising the first communication line and the second communication line, is received through either one of the communication lines, then, the electric devices execute various control operations such as shift position change-over, etc. by using the data that is received.

In this case, however, the network constituted by the other communication line is in a state of not being capable of normally communicating the data. Therefore, if this state is left to stand, then even the network capable of normally communicating the data may become faulty, and the vehicle drive system may fail to normally operate.

As described in claim 37, therefore, when the data, that is to be transmitted through the communication lines of two systems comprising the first communication line and the second communication line, is received through either one of these communication lines, the electric devices judge that the communication system of the other communication line has failed, and notify this fact to an external unit (specifically, to a passenger such as the driver or an administrator outside the vehicle).

Namely, if the network built up by one of the two systems of communication lines has failed, then, the driver or the related personnel is urged to check and repair the network preventing such an occurrence that the networks of the two systems have both failed and the vehicle drive system is not operable.

Further, even when the electric devices have received the data using the communication lines of two systems comprising the first communication line and the second communication line, the communication system of the vehicle drive system is susceptible to noise from various devices mounted on the vehicle or to noise from outside the vehicle, and an error may occur in the received data due to noise.

As described in claim 38, therefore, upon receipt of data transmitted through both the first communication line and the second communication line, the electric devices may judge the reliability of data and may employ the data having higher reliability as the received data.

This enables the electric devices such as the shift position control unit and the like devices to use the normal data without error as the received data to carry out the control operation even though the data obtained through one of the communication lines of the two systems contain errors. Thus, the vehicle drive system is prevented from malfunctioning, and the reliability of the vehicle is further heightened.

In the system described in claim 38, the procedure by which the electric devices judge the reliability of the received data may be as described in, for example, claim 39, i.e., checking at least one of (desirably all of) the period for receiving the data, continuity of data content from the data received in the past and validity of the data content.

Namely, when the period for receiving the data is different from the normal period, when the data received this time is not continuously changing from the data in the past, or when the data content is different from the normal content, it can be considered that some failure exists in the received data. Upon checking, therefore, the reliability of the received data can be correctly judged.

Next, the device according to the fifth aspect of the invention described in claim 40 is the shift position instruction detector unit suited for realizing the shift-by-wire system by utilizing the communication system of the vehicle drive system. The device according to the fifth aspect of the invention described in claims 41 to 47 is the shift position control unit suited for realizing the shift-by-wire system by utilizing the communication system of the vehicle drive system.

In the shift position instruction detector described in claim 40, detector means detects the shift position instruction input from the operation unit, and shift position instruction transmission control means converts the detected shift position instruction into transmission data, and transmits the transmission data, at a predetermined transmission timing, to the other electric devices from the first transmission means and the second transmission means connected to the first communication line and to the second communication line, respectively.

Further, the shift position controller described in claim 41 includes first communication means and second communication means for transmitting and receiving the data through the first communication line and the second communication line, and an operation means obtains the shift position instruction and the data representing the operating conditions of the vehicle out of the data received through both or one of the communication means and generates an optimum shift position of the transmission based on the obtained data, and the shift position change-over means changes the shift position of the transmission over to the optimum shift position.

With the communication system of the vehicle drive system being built by using the shift position instruction detector unit described in claim 40 and the shift position control unit described in claim 41, therefore, the shift position instruction input from the operation unit can be reliably transmitted from the shift position instruction detector unit to the shift position control unit to easily realize the communication system according to the fifth aspect-of the invention (claims 34 to 39) which makes it possible to easily build a highly reliable shift-by-wire system.

Next, the shift position control unit described in claim 42 is the one described claim 41 provided with failure-in-the-communication notifying means which, when the data to be transmitted through both the first communication line and the second communication line are received through either the first communication means or the second communication means, so judges that the communication system has failed on the communication line to which the other communication means is connected, and notifies this fact to an external unit.

If failure has occurred in one of the communication lines of the two systems to which the first communication means and the second communication means are connected, therefore, the shift position control unit urges the driver to check and repair the network built up by using the above communication line, preventing such an occurrence that the networks of the two systems built up by the communication lines have both failed making it impossible to change over the shift position.

The shift position control unit described in claim 43 is the one described in claim 41 or 42 provided with reliability judging means which, when the same data are received through the first communication means and the second communication means, judges the reliability of the data, and sets the data having high reliability as the data which the operation means uses for generating the optimum shift position.

Therefore, the shift position control unit changes over the shift position by using normal data without error even if an error is contained in the data obtained through the communication lines of the two systems to which the first communication means and the second communication means are connected, thus improving the reliability of the shift-by-wire system.

The reliability judging means may judge the reliability of the received data by judging, as described in claim 44, at least one of the period for receiving the data, continuity of the data content from the data received in the past, and validity of the data content.

Namely, when the period for receiving the data is different from the normal period, when the data received this time is not continuously changing from the data in the past, or when the data content is different from the normal content, it can be considered that some failure exists in the received data. By constituting the reliability judging means as described in claim 44, therefore, reliability of the received data can be correctly judged.

In the shift position controller according to the fifth aspect of the invention (claims 41 to 44), the operation means finds an optimum shift position of the transmission and the shift position change-over means changes the shift position of the transmission over to the optimum shift position. However, if a failure such as breakage of a line has occurred in the transmission path (i.e., signal line in the shift position controller) through which the shift position change-over instruction is transmitted from the operation means to the shift position change-over means or if the operation means itself malfunctions, it becomes impossible to change over the shift position of the transmission even though the communication lines (networks) to which the communication means are connected are normally functioning.

In order to prevent the above problem, therefore, the shift position controller may be constituted as described in claim 45 or claim 46.

Namely, the shift position controller described in claim 45 is provided with second reception means for receiving the data through the second communication line, wherein the operation means not only sends the shift position change-over instruction corresponding to the generated result of the optimum shift position to the shift position change-over means but also converts the shift position change-over instruction into transmission data to be transmitted from the second communication means on the second communication line.

Further, the shift position change-over means changes over the shift position of the transmission according to the shift position change-over instruction input from the operation means, and changes over the shift position of the transmission according to the shift position change-over instruction received through the second reception means when the data representing the shift position change-over instruction is received through the second reception means.

According to the shift position control unit described in claim 45, therefore, the shift position change-over instruction is transmitted from the operation means to the shift position change-over means through a path of second communication means—second communication line—second reception means even when a failure has occurred in the path for transmitting the shift position change-over instruction from the operation means to the shift position change-over means making it difficult to directly send the shift position change-over instruction from the operation means to the shift position change-over means. Accordingly, the shift position change-over means changes over the shift position of the transmission according to the shift position change-over instruction from the operation means.

Like the shift position control unit described in claim 45, the shift position control unit described in claim 46 is provided with second reception means for receiving the data through the second communication line, wherein the shift position change-over means monitors the operation state of the operation means and, when the operation of the operation means is faulty, changes over the shift position of the transmission according to the data representing the shift position instruction from the shift position instruction detector unit received by the second communication means.

According to the shift position control unit described in claim 46, therefore, even when the operation means fails to normally operate, the shift position change-over means changes over the shift position of the transmission according to the shift position instruction transmitted from the shift position instruction detector through a path of shift position instruction detector—second communication line—second reception means.

Therefore, the shift position control units described in claims 45 and 46 prevent such an occurrence that the shift position of the transmission cannot be changed over due to the fault in the shift position control unit itself, further improving the reliability of the shift-by-wire system.

The shift position control units described in claim 45 and 46 may be implemented independently of each other, or may be simultaneously implemented for the shift position control unit described in any one of claims 41 to 44.

Namely, the shift position control unit described in any one of claims 41 to 44 is provided with the second reception means that receives the data through the second communication line. The operation means is so constituted that the shift position change-over instruction corresponding to the operated result of the optimum shift position is sent to the shift position change-over means and that the shift position change-over instruction is converted into the transmission data and is transmitted onto the second communication line from the second communication means. Further, the shift position change-over means is so constituted that the shift position of the transmission is normally changed over according to the shift position change-over instruction input from the operation means, that the shift position of the transmission is changed over according to the shift position change-over instruction received through the second reception means when the shift position change-over instruction is not input from the operation means but the data representing the shift position change-over instruction is received through the second reception means, and that the shift position of the transmission is changed over according to the data representing the shift position instruction from the shift position instruction detector received by the second communication means while monitoring the operating condition of the operation means and when the operation of the operation means is faulty.

As compared to when the invention of claim 45 and the invention of claim 46 are implemented independently of each other, therefore, the above shift position control unit further improves the reliability of the shift-by-wire system.

Further, the shift position control unit according to the fifth aspect of the invention (claims 41 to 46) can be applied to the automatic transmission of which the shift position is changed over to the drive “D” position, reverse “R” position or neutral “N” position according to a shift position instruction input by the driver who operates the operation unit, and can further be applied to the manual transmission of which the shift position (speed-change gear) is changed over according to a shift position instruction. When applied to the automatic transmission, in particular, it is desired that the shift position controller is constituted as described in claim 47.

Namely, in the shift position controller described in claim 47, when the present shift position of the automatic transmission can be changed, the operation means is so constituted as to generate an optimum gear position of the automatic transmission based upon the data representing the operating conditions of the vehicle obtained out of the data received through both or either one of the first communication means and the second communication means, and provision is further made of gear position change-over means for changing the gear position of the automatic transmission over to an optimum gear position operated by the operation means.

Namely, the shift position controller described in claim 47 is furnished with a function as a transmission controller for controlling the automatic transmission depending upon the operating conditions of the vehicle, and is equivalent to the conventional transmission controller which is integrally provided with a shift position controller that constitutes a shift-by-wire system.

Here, the shift position control unit constituted as described above suppresses an increase in the number of the electric devices constituting the vehicle drive system in building up the shift-by-wire system on the vehicle which mounts an automatic transmission, and helps improve workability in building up the communication system on the vehicle according to the fifth aspect of the invention.

If the shift position control unit and the transmission control unit are fabricated together as a unitary structure, however, the operation means must execute a complex arithmetic processing and, besides, an increased number of signal lines must be arranged in the device. It is therefore desired to apply the invention described in claim 45 or claim 46 to maintain reliability of the shift-by-wire system.

The operation for changing over the shift position of the automatic transmission includes a so-called P lock for locking the shift position of the automatic transmission to prevent the rotation of the power transmission system which transmits the power from the automatic transmission to the drive wheels when the operation unit is operated to the parking “P” position which instructs the parking of the vehicle. The P lock may be effected by the shift position control unit, may be effected by the transmission control unit separate from the shift position control unit, or a control unit may be separately provided exclusively for the P lock.

In this case, it is desired that the P lock control unit is connected to the communication lines (first communication line and second communication line) of two systems like the shift position control unit, and that a parking position instruction is transmitted as a shift position instruction from the shift position instruction detector unit to the P lock control unit.

It is further desired that the shift position control unit is provided with shift position data transmission control means for transmitting the data representing the latest shift position of the transmission changed over by the shift position change-over means to the other electric devices through the first communication means or through the first communication means and the second communication means.

Then, the other electric devices such as the engine control unit and the transmission control unit constituting the communication system of the vehicle drive system can be informed of the shift position of the transmission to improve the reliability of the control operation executed by these devices.

### BRIEF DESCRIPTION OF THE DRAWINGS

FIG. 1 is a diagram schematically illustrating the constitution of a portion of a communication system in the power train system according to a first embodiment of the invention;

FIG. 2 is a flowchart illustrating a communication processing (A);

FIG. 3 is a flowchart illustrating a communication processing (B);

FIG. 4 is a flowchart illustrating a communication processing (C);

FIG. 5 is a flowchart illustrating a data transmission processing executed in the communication processing (C);

FIGS. 6a and 6b are flowcharts illustrating a data reception processing executed in the communication processing (C);

FIG. 7 is a block diagram illustrating the constitution of the vehicle communication system according to a second embodiment of the invention;

FIG. 8 is a block diagram illustrating the constitution of the ECUs according to the second embodiment;

FIG. 9 is a flowchart illustrating a data transmission processing executed by the ECUs according to the second embodiment;

FIG. 10 is a flowchart illustrating a reception line change-over processing executed by the ECUS according to the second embodiment;

FIG. 11 is a flowchart illustrating a processing for taking a majority of important data at all times executed by the ECUs according to a modified example of the second embodiment;

FIG. 12 is a block diagram illustrating the constitution of the vehicle communication system according to a third embodiment;

FIG. 13 is a flowchart illustrating a data transmission processing executed by a power control ECU according to the third embodiment;

FIG. 14 is a flowchart illustrating a data transmission monitor processing executed by the ECUs according to the third embodiment;

FIG. 15 is a flowchart illustrating a power load monitor processing executed by the power control ECU according to the third embodiment;

FIG. 16 is a flowchart illustrating a reception line change-over processing executed by the control ECU according to the third embodiment;

FIG. 17 is a block diagram illustrating the constitution of the vehicle communication system according to a fourth embodiment;

FIGS. 18a to 18c are block diagrams illustrating the constitutions of a control ECU, of an intelligent sensor and of an intelligent actuator that constitute the network according to the fourth embodiment;

FIG. 19 is a diagram schematically illustrating the constitution of the communication system in the vehicle drive system according to a fifth embodiment of the invention;

FIG. 20 is a flowchart illustrating a shift position instruction detection/transmission processing executed by a shift position instruction detector unit;

FIG. 21 is a flowchart illustrating a shift position control processing executed by the shift position controller unit;

FIGS. 22a and 22b are flowcharts illustrating a data reception processing executed by the shift position controller unit;

FIG. 23 is a diagram illustrating the constitution of the shift position controller unit according to a modified example; and

FIG. 24 is a diagram illustrating the constitution of when the shift position controller unit and the transmission ECU are fabricated together as a unitary structure.

### DESCRIPTION OF THE PREFERRED EMBODIMENTS

A first embodiment to which a first aspect of the invention is applied will now be described with reference to the drawings. The aspect of the invention is in no way limited to the following embodiment only but can take a variety of forms so far as they pertain to the technical scope of the present invention.

[First Embodiment]

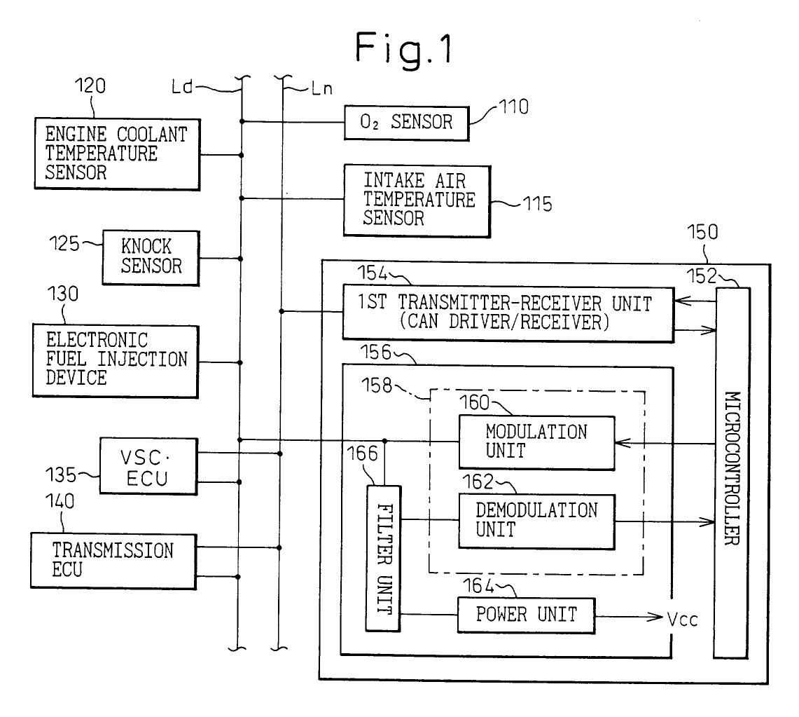

FIG. 1 is a diagram schematically illustrating the constitution of a communication system in the power train system of an automobile. As shown in FIG. 1, the communication system includes an O₂ sensor 110, an intake air temperature sensor 115, an engine coolant temperature sensor 120, a knock sensor 125, an electronic fuel injection device 130, a VSC (vehicle stability control) ECU 135, a transmission ECU 140, and an engine ECU 150, which are connected to a power line Ld laid out like a bus. The VSC ECU 135, the transmission ECU 140 and the engine ECU 150 are further connected to a communication line Ln laid out like a bus.

The O₂ sensor 110 is mounted on an engine exhaust pipe that is not shown to measure the concentration of oxygen in the exhaust gas. The intake air temperature sensor 115 is mounted on an engine intake pipe to measure the temperature of the air taken in by the engine. The engine coolant temperature sensor 120 is mounted on an engine coolant circulatory system to measure the temperature of the engine coolant. The knock sensor 125 is mounted on an engine block to measure abnormal vibration of the engine. The electronic fuel injection device 130 is mounted in the intake air stream of the engine to electrically control the amount of fuel injection.

The engine ECU 150 obtains the data measured by the O₂ sensor 110, intake air temperature sensor 115, engine coolant temperature sensor 120 and knock sensor 125, and sends an instruction to the electronic fuel injection device 130 to control the operation of the engine.

The VSC ECU 135 is a vehicle stability control system ECU which sends an instruction to the engine ECU 150 based on the data from the acceleration sensor and the wheel rotation sensor that are not shown in order to suppress the engine output, and sends an instruction to the brake actuator that is not shown to control the rotational speed of the wheels thereby to stabilize the attitude of the vehicle.

The transmission ECU 140 controls the change of speed and disconnection of the automatic transmission that is not shown.

The power line Ld corresponds to a first communication line of the first embodiment of the invention, feeds the electric power from the battery that is not shown to the devices and transmits the superposed data among the devices. The communication according to this embodiment employs the time-division multiplex system in which the transmission timing and the reception timing alternately occurs according to a predetermined schedule. As for the communication system, there may be employed a frequency-division multiplex system in which a predetermined frequency is assigned for every transmission ECU or a code-division multiplex system in which a code is assigned. Or, there may be employed a CSMA/CR (carrier sense multiple access/collision resolution) system which arbitrates the access right prior to transmitting the data.

The communication line Ln corresponds to the second communication line according to the first embodiment of the invention and executes the communication among the devices connected together through the communication line Ln. The communication is effected by utilizing the CAN (“controller area network” proposed by Robert Bosch Co., Germany) which is a protocol usually employed by the car-mounted network.

Next, described below is the constitution inside the engine ECU 150. The interior of the ECU 150 includes chiefly a microcontroller 152, a first transmitter-receiver unit 54 and a power IC 156. The first transmitter-receiver unit 154 possesses a communication function and using the communication line Ln. The power IC 156 contains a second transmitter-receiver unit 158, a power unit 164 and a filter unit 166. The second transmitter-receiver unit 158 further includes a modulation unit 160 and a demodulation unit 162. The modulation unit 160 modulates the transmission data to form transmission signals which are transmitted by being superposed on the power line Ld. The demodulation unit 162 demodulates the signal components taken out by the filter unit 166 from the power line Ld to take them out as received data. The power unit 164 produces a DC constant voltage Vcc from which the signal components have been removed by the filter unit 166. The circuit in the engine ECU 150 operates on the DC constant voltage Vcc. The microcontroller 152 controls the first transmitter-receiver unit 154 and the power IC 156 together.

Here, the O₂ sensor 110, intake air temperature sensor 115, engine coolant temperature sensor 120, knock sensor 125, electronic fuel injection device 130, VSC ECU 135, transmission ECU 140 and engine ECU 150 correspond to the electric devices according to the first aspect of the invention. Among them, the VSC ECU 135, transmission ECU 140 and engine ECU 150 correspond to the special electric devices.

The communication processing in the thus constituted communication system will now be described by being divided into a communication processing (A) executed by the sensors such as the O₂ sensor 110, intake air temperature sensor 115, engine coolant temperature sensor 120 and knock sensor 125, a communication processing (B) executed by the actuators such as the electronic fuel injection device 130, and a communication processing (C) executed by the ECUs such as the VSC ECU 135, transmission ECU 140 and engine ECU 150.

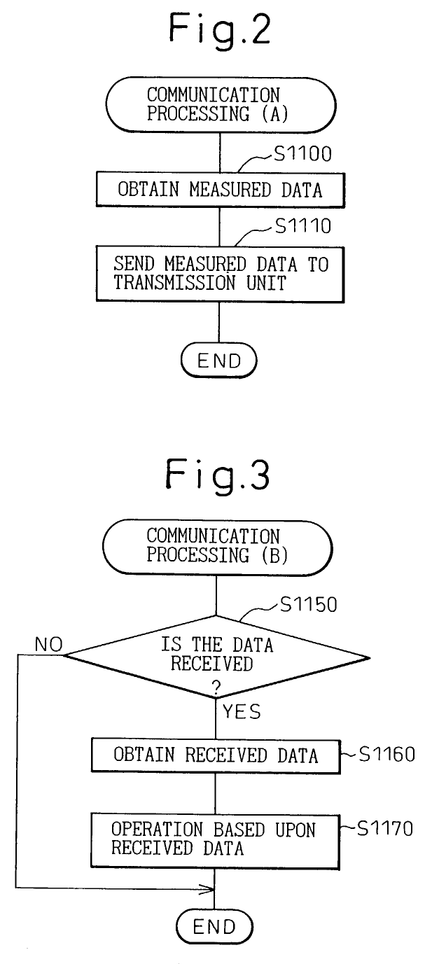

First, the communication processing (A) executed by the O₂ sensor 110 will be described with reference to a flowchart of FIG. 2. This processing is regularly executed at a predetermined time interval. Hereinafter “S” stands for a step.

At S1100, first, a sensor unit that is not shown measures the concentration of oxygen being controlled by a control unit that is not shown. Then, at S1110, the control unit sends the data measured by the sensor unit to a transmission unit that is not shown to end the processing. The transmission unit that has received the measured data judges whether the power line Ld is in a state capable of transmitting the data. When it is capable of transmitting the data, the measured data is superposed as a transmission signal on the power line Ld so as to be output. When it is not capable of transmitting the data, a timing for transmitting the data is waited for. When a timing capable of transmitting the data has arrived, the measured data is superposed as a transmission signal on the power line Ld so as to be output.

Next, the communication processing (B) executed by the electronic fuel injection device 130 will be described with reference to a flowchart of FIG. 3. This processing, too, is regularly executed at a predetermined time interval.

At S1150, first, the control unit that is not shown judges whether the receiver unit has received data. When data has been received, the routine proceeds to S1160. When no data has been received, the processing ends. The receiver unit has been so constituted as to obtain and hold the data directed to the electronic fuel injection device 130 from the power line Ld without the control unit being interposed therein. At S1160, the control unit obtains the received data from the receiver unit. At a subsequent S1170, the fuel injection unit that is not shown injects the fuel based upon the received data under the control of the control unit, and the processing ends.

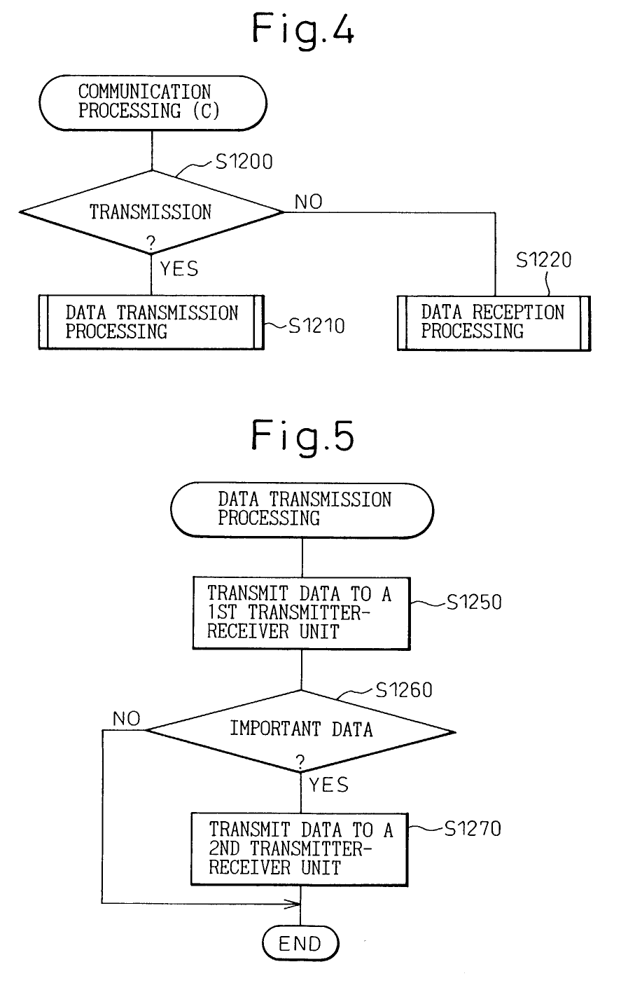

Next, the communication processing (C) executed by the engine ECU 150 will be described with reference to flowcharts of FIGS. 4 to 6. This processing is executed for transmitting or receiving the data while a processing is being executed based on a program stored in the microcontroller 152.

At S1200, first, it is judged whether the transmission processing be executed. When the transmission processing is to be executed, the routine proceeds to S1210. When the transmission processing is not to be executed, i.e., when the reception processing is to be executed, the routine proceeds to S1220. At S1210, the data transmission processing is executed. At S1220, the data reception processing is executed.

Here, the data transmission processing at S1210 will be described in detail with reference to the flowchart of FIG. 5. At S1250, first, the microcontroller 152 sends transmission data to the first transmitter-receiver unit. When the transmission data is a predetermined important data, the data is output after data stating that the data is important data is contained in the header of the transmission data. The first transmitter-receiver unit that has received the transmission data sends the transmission data to the communication line Ln according to the CAN communication rule.

At a subsequent S260, the routine branches depending upon whether the transmission data is a predetermined important data. When it is the important data, the routine proceeds to S1270. When it is not the important data, the processing ends.

At S1270, the microcontroller 152 sends the transmission data to the second transmitter-receiver unit to end the processing. The second transmitter-receiver unit that has received the transmission data judges whether the power line Ld is in a state capable of transmitting the data. When it is capable of transmitting the data, the transmission data are superposed as transmission signal on the power line Ld so as to be output. When it is not capable of transmitting the data, a timing for transmitting the data is waited for. When a timing capable of transmitting the data has arrived, the transmission data are superposed as transmission signals on the power line Ld so as to be output.

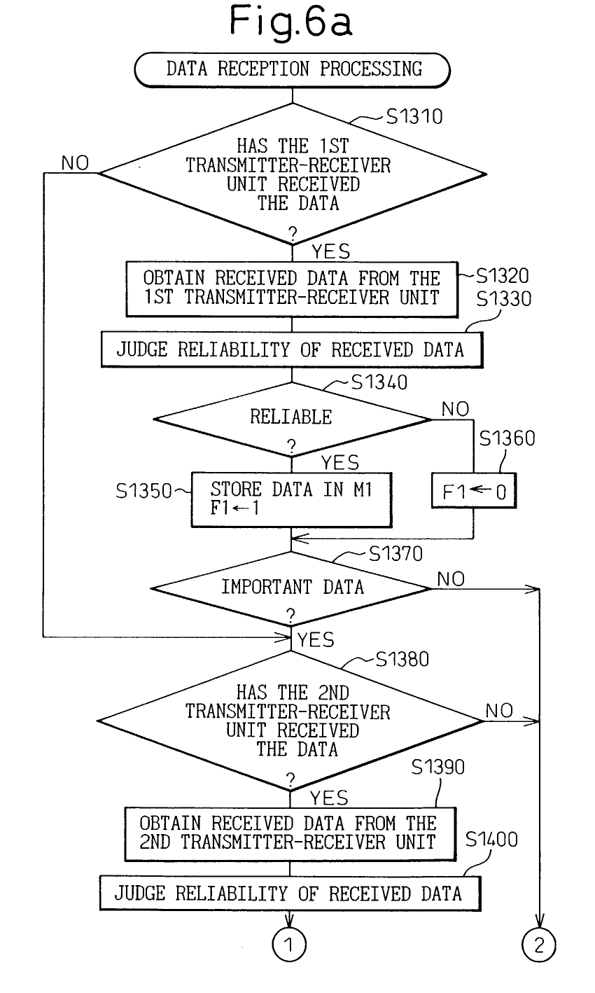

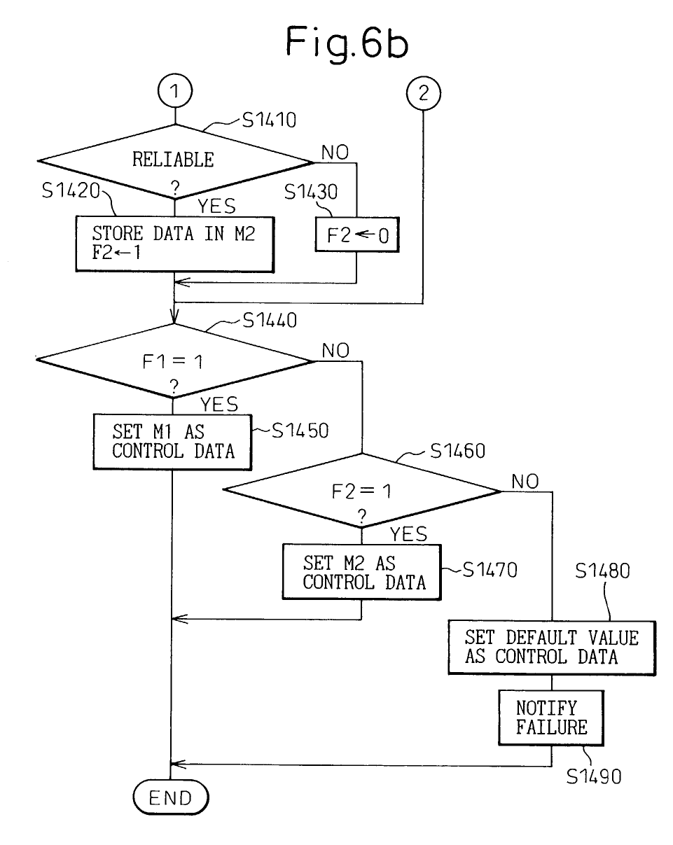

Next, the data reception processing at S1220 of FIG. 4 will be described in detail with reference to the flowchart of FIG. 6. At S1310, first, the microcontroller 152 judges whether the first transmitter-receiver unit 154 has received data. When the data has been received, the routine proceeds to S1320. When no data is received, the routine proceeds to S1380.

At S1320, the microcontroller 152 obtains the received data in the first transmitter-receiver unit 154 and stores it in a temporary memory region that is not shown in the microcontroller 152. At subsequent S1330, the microcontroller judges the reliability of the received data. The reliability can be judged by using an error detection code such as a checksum or a CRC, by judging whether the period for receiving the data is normal, by judging whether the data received this time is continuously changing from the data received in the past, or by judging whether the data value is within a normally occurring range. The criteria of judgement are set based upon a limit at which the function of the communication system is safely realized and a limit at which the user such as the driver recognizes that the operation is within a normally operating range.

At S1340, the routine branches depending upon the result of judgement at S1330. When the received data is reliable, the routine proceeds to S1350. When the received data is not reliable, the routine proceeds to S1360.

At S1350, the received data is stored in a memory region M1 that is not shown in the microcontroller 152, and 1 is set to a flag F1 which is for temporarily storing the result of judging the reliability. The routine, then, proceeds to S1370. At S1360, on the other hand, 0 is set to the flag F1 which is for temporarily storing the result of judging the reliability. The routine, then, proceeds to S1370. Zero is set to the flag F1 and to a flag F2 that will be described later at the time of starting the data reception processing.

At S1370, whether the data is important is judged from the header of the received data. The routine proceeds to S1380 when it is important data and proceeds to S1440 when it is not important data.

At S1380, it is judged whether there is received data at the second transmitter-receiver unit 158. The routine proceeds to S1390 when there is received data and proceeds to S1440 when there is no received data.

At S1390, the microcontroller 152 obtains the received data at the second transmitter-receiver unit 158 and stores it in the temporary storing region in the microcontroller 152. At a subsequent S1400, the reliability of the received data is judged. The reliability is judged by the same method as the one used for judging the reliability of the received data obtained from the first transmitter-receiver unit 154.

At a subsequent S1410, the routine branches depending upon the result of judgement at S1400. The routine proceeds to S1420 when the received data is reliable and proceeds to S1430 when the received data is not reliable.

At S1420, the received data is stored in a memory region M2 that is not shown in the microcontroller 152, and 1 is set to the flag F2 which is for temporarily storing the result of judging the reliability. The routine, then, proceeds to S1440. At step S1430, on the other hand, 0 is set to the flag F2 which is for temporarily storing the result of judging the reliability, and the routine proceeds to S1440.

At S1440, it is judged whether 1 has been set to the flag F1, i.e., whether the first transmitter-receiver unit 154 has received the reliable data from the communication line Ln. The routine proceeds to S1450 when 1 has been set (received) and proceeds to S1460 when 1 has not been set (has not been received).

At S1450, the value (reliable data which the first transmitter-receiver unit 154 has received from the communication line Ln) in the memory region M1 is set as data used for the control operation. By using this data, the microcontroller 152 executes a variety of operations to control the engine.

At S1460, it is judged whether 1 has been set to the flag F2, i.e., whether the second transmitter-receiver unit 158 has received reliable data from the power line Ld. The routine proceeds to S1470 when 1 has been set (received) and proceeds to S1480 when 1 has not been set (has not been received).

At S1470, the value (reliable data which the second transmitter-receiver unit 158 has received from the power line Ld) in the memory region M2 is set as data used for the control operation. By using this data, the microcontroller 152 executes a variety of operations to control the engine.

At S1480, a predetermined default value is set as the data for the control operation.

At a subsequent S1490, as no reliable data has been received, an alarm lamp in the compartment is turned on or alarm sound is produced to notify this fact to the occupant of the vehicle. Then, the processing ends.

According to the communication system of this embodiment as described above, the communication among the devices 110, 115, 120, 125, 130, 135, 140 and 150 is effected by using the power line Ld to decrease the number of the lines. Besides, the ECUs 135, 140 and 150 are further connected to the communication line Ln, and the data are communicated among the ECUs 135, 140 and 150 by using the communication lines of two systems, i.e., the communication line Ln and the power line Ld.

Accordingly, the communication system of this embodiment features improved reliability while decreasing the number of the lines.

The data which the ECUs 135, 140 and 150 transmit to the power line Ld are important data only. Therefore, reliability can be improved by suppressing the communication speed on the power line Ld as compared to transmitting the same data onto both the power line Ld and the communication line Ln.

In executing the communication among the ECUs 135, 140 and 150 and, further, when the data transmitted through the power line Ld and the data transmitted through the communication line Ln both have low reliability, the data that has been stored in advance is used. This makes it possible to at least maintain the function of the communication system and, hence, to maintain reliability.

When the data received through the power line Ld as well as the communication line Ln are faulty, the ECUs 135, 140 and 150 notify this fact to the occupant of the vehicle. This makes it possible to prevent such an occurrence that the communication lines of the two systems are both faulty and the function of the communication system is not realized. This further helps locate a faulty portion.

The above-mentioned embodiment has dealt with the communication system including the O₂ sensor 110, intake air temperature sensor 115, engine coolant temperature sensor 120, knock sensor 125, electronic fuel injection device 130, VSC ECU 135, transmission ECU 140 and engine ECU 150 as electric devices. Not being limited thereto only, however, it is also allowable to include various kinds of other electric devices.

The above-mentioned embodiment has dealt with the case where the ECUs receive the data through the two systems, i.e., a method which, if described concerning, for example, the engine ECU 150, uses the data which the second transmitter-receiver unit 158 has received when the data received by the first transmitter-receiver 154 is not reliable. It is, however, also allowable to employ a method which, when the data received by the first transmitter-receiver unit 154 is not very reliable, compares the data received by the first transmitter-receiver unit 154 with the data received by the second transmitter-receiver unit 158, and uses the data having higher reliability. Or, it is further allowable to employ a method which compares the data received by the first transmitter-receiver unit 154 with the data received by the second transmitter-receiver unit 158, and uses the data having higher reliability. This also makes it possible to obtain the same effects as those of the above embodiment.

In the above embodiment, the data stored in advance is used when the data which the ECUs have received are all not reliable. It is, however, also possible to use the data received in the past in its place. Or, the ECUs may have the data reissued. Either method is helpful for improving reliability.

As a method of improving reliability, it can be further contrived to repetitively transmit the same data through the same communication systems. This helps improve reliability though the amount of data communication increases.

The power line Ld and the communication line Ln may be constituted by one network, respectively, or may be constituted being divided into sub-networks connecting the related devices. This suppresses the amount of data communication through each network, prevents a situation where, if a fault has occurred, the functions are all disabled by the fault, and, hence, improves reliability.

In the above embodiment, ECUs are regarded as special electric devices. However, important sensors and actuators, too, may be regarded as special electric devices, and the communication may be executed for them in two systems. Further, the electric devices may be all special electric devices. Though this sacrifices the advantage of decreasing the number of the lines, the function of the vehicle communication system is more reliably maintained.

[Second Embodiment]

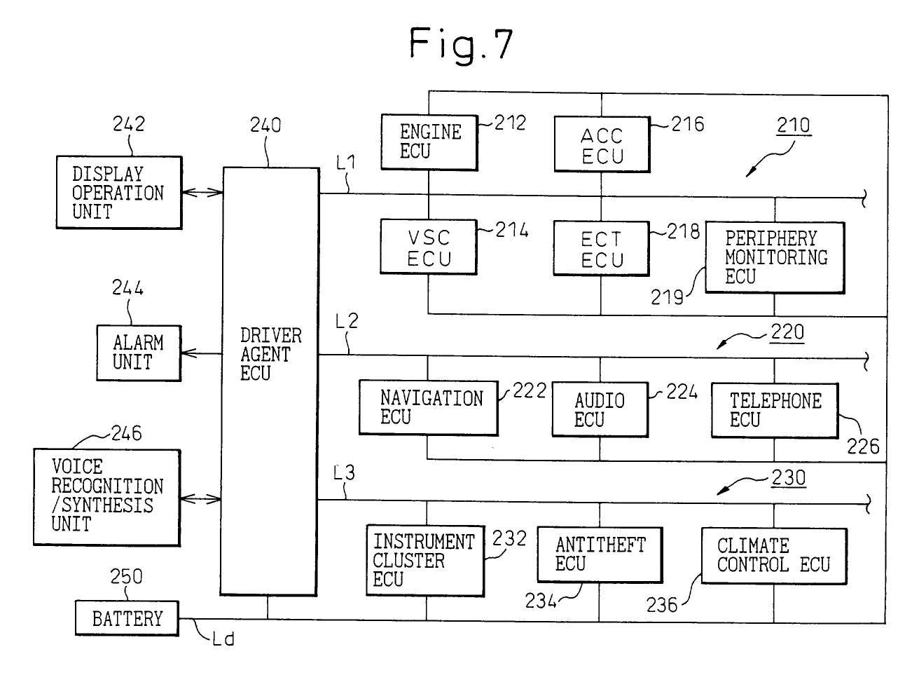

FIG. 7 is a diagram illustrating the constitution of the vehicle communication system according to the second embodiment to which the second and third aspects of the invention are applied.

Referring to FIG. 7, the vehicle communication system according to this embodiment comprises a control system network 210 connecting an engine ECU 212, a VSC ECU 214, an ACC ECU 216, an ECT ECU 218 and a periphery monitoring ECU 219 through a network-dedicated communication line L1, a data system (AVC system) network 220 connecting a navigation ECU 222, an audio ECU 224 and a telephone ECU 226 through a network-dedicated communication line L2, and a body system network 230 connecting an instrument cluster ECU 232, an antitheft ECU 234 and an climate control ECU 236 through a network-dedicated communication line L3. The ECUs are electronic control units constituted chiefly by microcontrollers and correspond to the electric devices described in claims 11-13.

A driver agent ECU 240 is connected to the communication lines of the networks 210, 220 and 230.

The driver agent ECU 240 works as a so-called gateway device for relaying the data shared by the networks 210, 220 and 230. Upon receipt of an operation instruction or a voice instruction from the driver through a display operation unit 242 or a voice recognition/synthesis unit 246 provided near the driver's seat of the vehicle, the driver agent ECU 240 transmits the data representing the content of instruction to predetermined ECUs through the networks 210, 220, 230.

Upon receipt of display data, voice data or alarm data for giving various kinds of guidance to the driver from the ECUs connected to the networks 210, 220 and 230, further, the driver agent ECU 240 displays messages on the display operation unit 242 according to the data, generates synthesized voice for giving various kinds of guidance through the voice recognition/synthesis unit 246, or generates an alarm sound through an alarm unit 244.

The engine ECU 212 that constitutes the control system network 210 is an engine control unit for controlling the engine, and the ECT ECU 218 is a transmission control unit for controlling the gear of the automatic transmission. Both of these units are control units of the so-called power train system. Further, the VSC ECU 214 is a control unit for controlling the attitude and braking of the vehicle, and the ACC ECU 216 is a travel control unit for controlling the vehicle to follow the preceding vehicle. These units are the controllers of the so-called vehicle motion system. Further, the periphery monitor ECU 219 is provided with various kinds of sensors for detecting the conditions surrounding the vehicle, and transmits the results detected by the sensors to the ECUs.

Further, the navigation ECU 222 constituting the AVC system network 220 controls the navigation unit, the audio ECU 224 controls audio devices such as a radio and a CD drive mounted on the vehicle, and the telephone ECU 226 controls the telephone mounted on the vehicle.

Further, the instrument cluster ECU 232 constituting the body system network 230 displays, on the display unit, various conditions of the vehicle such as vehicle speed, engine rotational speed, door opened/closed state, shift range of the transmission, etc., the antitheft ECU 234 monitors the state of the vehicle and produces an alarm or informs an external emergency center if any unauthorized person tries to enter into the vehicle or tries to steal equipment from the vehicle, and the climate control ECU 236 controls the air-conditioning unit mounted on the vehicle to optimize the temperature in the compartment.

The ECUs operate upon being supplied with the electric power from a battery 250, which is a car-mounted power source, through the power line Ld arranged in the vehicle. In this embodiment, the power line Ld is used as a communication line by the ECUs. Among various data transmitted through the networks 210, 220 and 230, predetermined important data are doubly transmitted and received using the power line Ld.

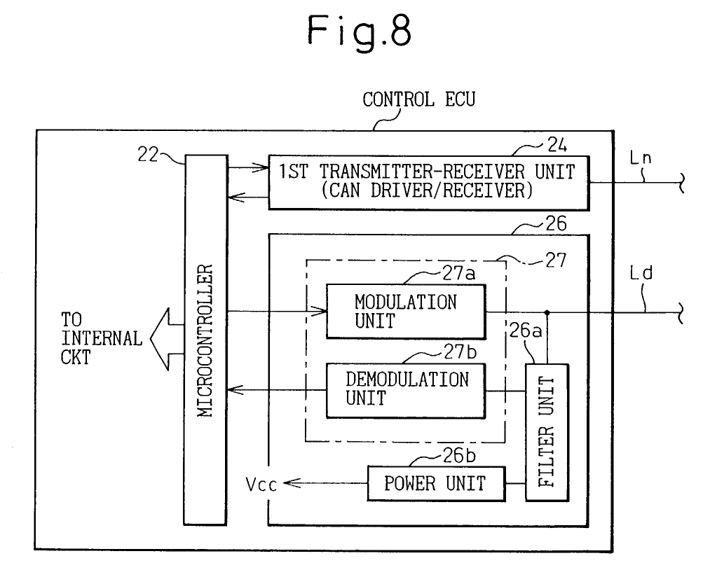

Namely, as shown in FIG. 8, each ECU includes, in addition to the dedicated circuit (internal circuit) for effecting the above various control operations, a microcontroller 22 for executing an arithmetic processing for the control operation, a first transmitter-receiver unit 24 for transmitting and receiving the data to and from the other ECUs on the network to which the ECU pertains through the communication line Ln (n is 1, 2 or 3) according to a program that has been set in advance to the microcontroller 22, and a power IC 26 connected to the power line Ld.

The power IC 26 is constituted by a filter unit 26 for picking up a DC voltage fed from the battery 250 through the power line Ld and for picking up high-frequency signal components for data communication flowing through the power line Ld, a power unit 26b for forming a constant DC voltage Vcc for operating the circuits in the ECUs from the DC voltage from which the high-frequency signal components have been removed by the filter unit 26a, and a second transmitter-receiver unit 27 for communicating the data with the other ECUs through the power line Ld. The second transmitter-receiver unit 27 is constituted by a modulation unit 27a which modulates the carrier waves used for data communication based on the data transmitted from the microcontroller 22 to form transmission signals and to superpose them on the power line Ld, and a demodulation unit 27b which receives the high-frequency signal components for data communication picked up by the filter unit 26a and demodulates them into the received data.

Therefore, the microcontroller 22 transmits and receives the data to and from the microcontrollers in other ECUs by using both the communication line Ln and the power line Ld.

In this embodiment, a CAN driver/receiver is used as the first transmitter-receiver unit 24 that executes the data communication by using the communication line Ln, i.e., to execute the data communication by utilizing the CAN (“controller area network” proposed by Robert Bosch Co., Germany) which is a protocol generally used by the car-mounted network.

On the other hand, the modulation unit 27a and the demodulation unit 27b constituting the second transmitter-receiver unit 27 transmit and receive the data in compliance with the same CAN protocol as that of the first transmitter-receiver unit 24. However, undesired high-frequency noise tends to be easily superposed on the power line Ld which is the communication line and, besides, the voltage easily fluctuates as the electric load circuits are closed. In order to maintain reliability in the data communication, therefore, the communication speed (e.g., 10 kbps) has been set to be slower than the communication speed (e.g., 500 kbps) of the first transmitter-receiver unit 24.

In this embodiment, therefore, the first transmitter-receiver unit 24 corresponds to the high-speed communication means of the second aspect of the invention or to the first communication means of the third aspect of the invention, and the second transmitter-receiver unit 27 corresponds to the low-speed communication means of the second aspect of the invention or to the second communication means of the third aspect of the invention.

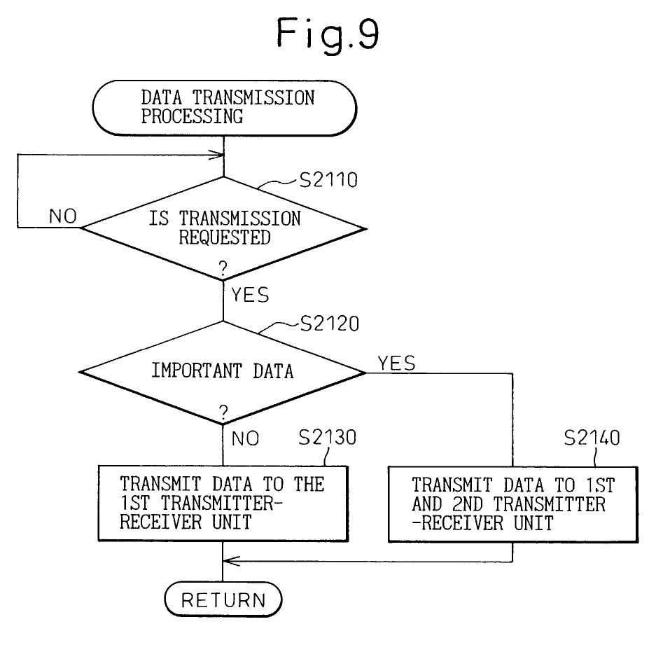

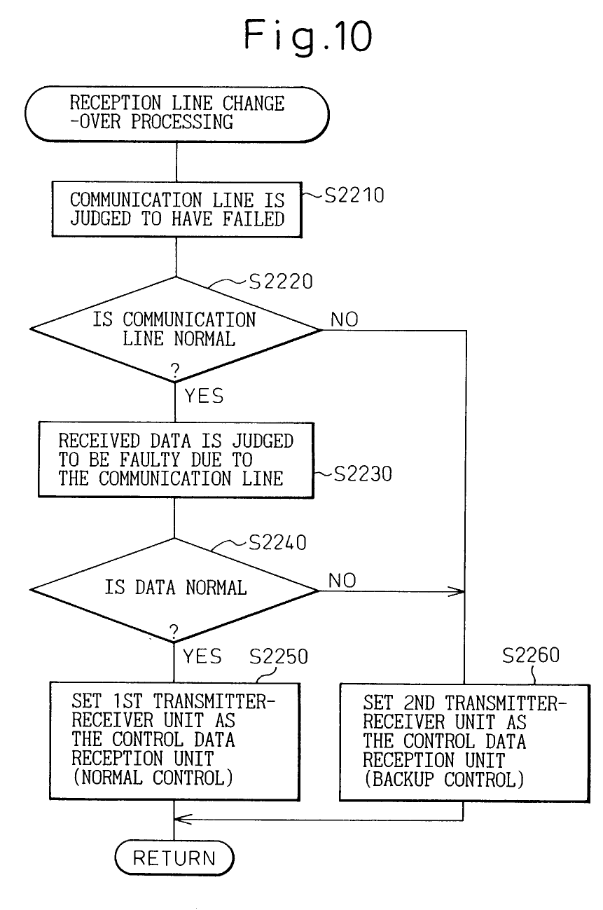

Next, FIG. 9 is a flowchart illustrating data transmission processing that is executed when the microcontroller 22 in the thus constituted ECUs is to transmit the data to other ECUs, and FIG. 10 is a flowchart illustrating a reception line change-over processing executed for selecting whether the data received through the communication line Ln is used or the data received through the power line Ld is used while the microcontroller 22 executes a variety of arithmetic processings.

In the data transmission processing as shown in FIG. 9, the microcontroller 22 judges whether there is a request for transmitting the data to the other ECUs while executing the arithmetic processings, and waits for the request of transmission (S2110).

When there is a request for transmission (S2110, YES), the routine proceeds to S2120 where it is judged whether the data that is to be transmitted this time to the other ECUs is a predetermined important data. When the transmission data is not the important data, the routine proceeds to S2130 where the data is transmitted to the first transmitter-receiver unit 24, whereby the data is transmitted from the first transmitter-receiver unit 24 onto the communication line Ln to once end the processing.

On the other hand, when the transmission data is the important data, the routine proceeds to S2140 where the data is transmitted to the first transmitter-receiver unit 24 and to the second transmitter-receiver unit 27, whereby the data is transmitted from the first transmitter-receiver unit 24 and the second transmitter-receiver unit 27 onto the communication line Ln and onto the power line Ld to once end the processing.

In transmitting the data to the other ECUs as described above, the microcontroller 22 transmits the data by using the communication line Ln and the power line Ld when the transmission data is the predetermined important data and, conversely, transmits the data by using the communication line Ln only when the transmission data is not the important data.

The important data are those which are at least necessary for executing various control operations by the ECUs to where the data are transmitted. In the case of the network 230 of the body system, for example, the important data may be instruction data transmitted to a head lamp turn-on control ECU (not shown) for instructing the turn on/off of head lamps, instruction data transmitted to a door lock/unlock ECU for instructing the locking or unlocking of the doors, and instruction data transmitted to a wiper drive ECU (not shown) for instructing the operation/stop of the wipers. In the case of the network 210 of the control system, the important data may be an immobilization signal transmitted to the engine ECU to permit the start of the engine, a collision detection signal for informing the ECUs of the collision of the vehicle, and a vehicle moving state signal for informing the ECUs of a yaw rate representing the moving state of the vehicle while the vehicle is traveling or the locking of the wheels.

The reception line change-over processing shown in FIG. 10 is for monitoring whether the main data communication executed through the first transmitter-receiver unit 24 has failed, and for changing the destination of receiving the data over to the side of the second transmitter-receiver unit 27 that executes the backup data communication only when the above data communication has failed, and is repetitively executed at regular intervals.

As the processing for judging the failure in the communication line Ln starts, first, the potential of the communication line Ln is received through the first transmitter-receiver unit 24 at S2210 to judge whether the potential is stably assuming the ground potential or the power source potential (Vcc) to thereby judge a breakage or a short-circuit of the communication line Ln.

Then, at S2220, the failure judgement processing judges whether the communication line Ln is normal. When it is judged that the communication line Ln has failed, the routine proceeds to S2260 to set the second transmitter-receiver unit 27 as the destination for receiving the data (control data receiver unit), and the processing ends.

On the other hand, when it is judged at S2220 that the communication line Ln is normal, the routine proceeds to S2230 where the data received through the communication line Ln is judged to be faulty.

The failure may be judged by, for example, regularly passing a check signal into the communication line Ln to judge that the received data is faulty in case the regularly supplied signals are not received for more than a predetermined period of time, or by regularly sending particular check data from the ECUs to judge that the received data is faulty in case the particular data are not received by the first transmitter-receiver unit 24 for more than a predetermined period of time, or by receiving the data through the first transmitter-receiver unit 24 to judge the fault in the received data by using a data check code (e.g., a CRC) attached to the data, or by a combination of the above judging operations.

Next, after the end of the failure judgement processing at S2230, it is judged at S2240 whether the received data is normal as a result of judgement. When the received data is normal, the first transmitter-receiver unit 24 is set at S2250 as the destination for receiving the data (control data receiver unit) to once end the processing. When the received data is not normal, on the other hand, the second transmitter-receiver unit 27 is set at S2260 as the control data receiver unit to end the processing.

When the first transmitter-receiver unit 24 is set at S2250 as the control data receiver unit, the microcontroller 22 receives all data necessary for the control operation through the communication line Ln and, hence, executes normal control operation. When the second transmitter-receiver unit 27 is set at S2260 as the control data receiver unit, however, the microcontroller 22 receives only the important data which are at least necessary for the control operation through the power line Ld. Therefore, the backup control is executed by using the important data.

According to the second embodiment, therefore, failure in the data communication through the communication line Ln is judged, and either the first transmitter-receiver unit 24 or the second transmitter-receiver unit 27 is selectively set as the control data receiver unit according to the result of judgement, as is done at S2210 to S2260 representing the selection means of claim 17 of the second aspect of the invention or the selection means of claim 26 of the third aspect of the invention.

In the vehicle communication system according to the second embodiment as described above, the power line Ld feeding the power source to the ECUs constituting the networks 210, 220 and 230 of the control system, AVC system and body system, is used as a backup communication line for the communication lines L1, L2 and L3 of the networks, and supplies the predetermined important data among the data supplied through the main communication line Ln (L1, L2, L3).

According to the vehicle communication system of the second embodiment, therefore, no matter in which network the data communication has failed, the important data transmitted and received through the network are reliably transmitted to the ECUs that require the important data, allowing improved reliability in the data communication. Further, even when the main data communication utilizing the communication line Ln has failed, the ECUs are able to obtain important data based upon the backup communication by using the power line Ld and are, hence, free from malfunctioning due to defective communication, thus enhancing safety while the vehicle is traveling.

According to the second embodiment, further, the power line Ld is used for the backup communication. Therefore, there is no need of separately arranging the communication line for backup communication in the vehicle, and the system can be cheaply realized. The power line Ld permits undesired high-frequency noise to be easily superposed thereon and, further, permits the voltage to easily fluctuate as the electric load circuit is closed, from which it can be presumed the reliability in the data communication is deteriorated. In this embodiment, however, the communication speed is decreased to be slower than that of the main data communication which uses the first transmitter-receiver unit 24 to enhance the reliability of data communication by using the power line Ld and to maintain reliable backup of the important data.

In the second embodiment, the main data communication utilizes the CAN protocol and the backup data communication utilizes the CAN protocol of which the communication speed is decreased to be slower than that of the main data communication. However, these data communications may utilize a protocol as such BEAN (body electronics area network), FlexRay (automotive network standard of the high-speed control system) or TTP (time triggered protocol). Or, the main data communication and the backup data communication may employ different protocols.

That is, the data communication may employ a protocol that is adapted to each network. For example, the above networks 210, 220 and 230 may be connected together by an IEEE 1394 backbone. The networks 210, 220, 230 and the data communication using the power line Ld may employ protocols that are suited thereto.

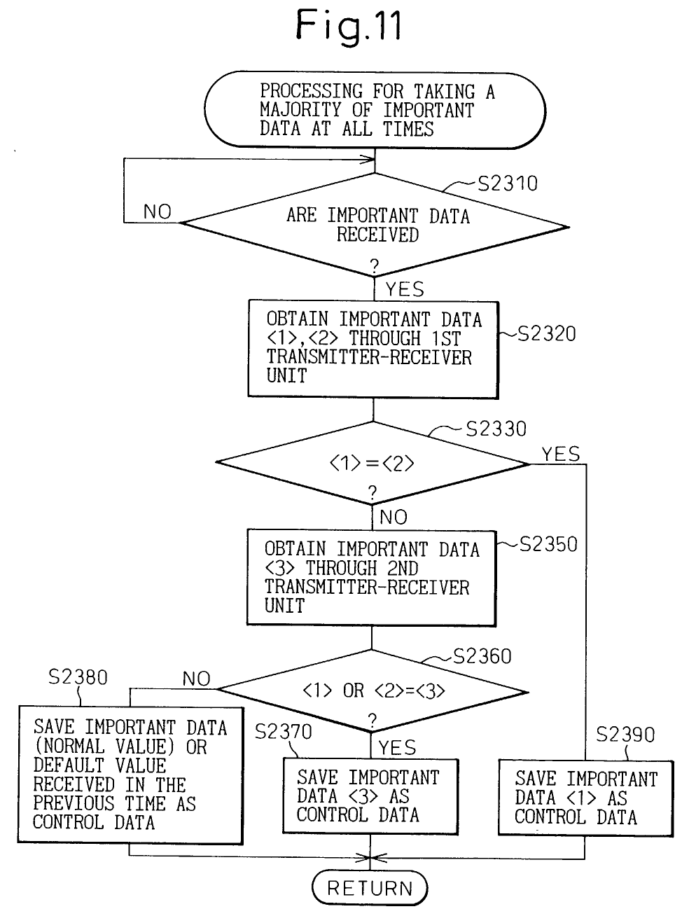

In the second embodiment, further, the microcontrollers 22 provided in the ECUs execute the reception line change-over processing shown in FIG. 10, and set the first transmitter-receiver unit 24 as the receiver unit for receiving the data if the communication line Ln is not defective. In the data transmission processing shown in FIG. 9, however, if the important data are transmitted twice in a time-dividing manner at the time of transmitting the important data from the first transmitter-receiver unit 24 at S2140, it becomes possible to more correctly obtain the important data during the normal operation when there is no fault in the communication line Ln by executing a processing for taking a majority of important data at all times shown in FIG. 11.

Namely, in the processing for taking a majority of important data at all times shown in FIG. 11, it is judged at S2310 whether the first transmitter-receiver unit 24 or the second transmitter-receiver unit 27 has received important data, and reception of important data is waited for. When the important data are received, two important data <1> and <2> are obtained at S2320 through the first transmitter-receiver unit 24, and it is judged whether these important data <1> and <2> are in agreement (S2330). When these important data <1> and <2> are in agreement, the important data <1> (or <2>) is saved as important data (control data) used for the control operation, and the processing ends.

When it is judged at S2330 that the important data <1> and <2> are not in agreement, on the other hand, important data <3> is obtained through the second transmitter-receiver unit, and it is judged whether the important data <3> is in agreement with either one of the important data <1> or <2> (S2360). When the important data <3> is in agreement with either one of the important data <1> or <2>, the important <3> is saved as control data at S2370. When the important data <3> is not in agreement with the important data <1> or <2> (i.e., when the three data received by the first transmitter-receiver unit 24 and the second transmitter-receiver unit 27 are all different from one another), it is so regarded that the reception of important data has resulted in failure. At S2380, therefore, the normal and important data received in the previous time or the data that has been set in advance as default value, is saved as control data, and the processing ends.

In case the important data obtained through one time of receiving operation has been altered, execution of the majority processing makes it possible to prevent the important data from being erroneously used for the control operation, and reliability of the ECUs is improved.

The majority processing shown in FIG. 11 corresponds to the selection means described in claim 18 of the second aspect of the invention or the selection means described in claim 27 of the third aspect of the invention.

[Third Embodiment]

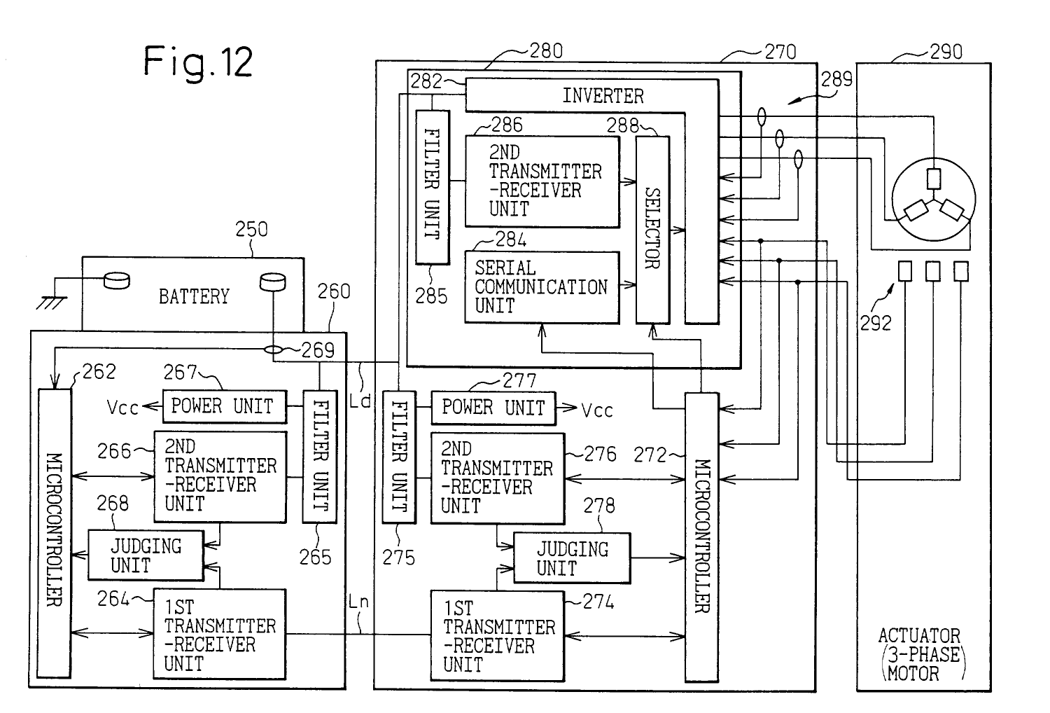

FIG. 12 is a block diagram illustrating the constitution of the vehicle communication system according to a third embodiment.

In the vehicle communication system according to the third embodiment, like that of the second embodiment, a plurality of ECUs (the drawing shows only two ECUs 260 and 270) are connected together through the communication line Ln so as to communicate the data, and the power line Ld for feeding the power source to the ECUs is used as a backup communication line for communicating the important data only.

The third embodiment is different from the second embodiment with respect to that a battery ECU 260 for monitoring the state of the battery 250 which is the car-mounted power source is provided as one of the ECUs connected to the communication line Ln, and that among the other ECUs connected to the communication line Ln, the control ECU 270 (concretely, engine ECU, ECT ECU, VSC ECU, etc.) for controlling the actuator (three-phase motor 290 in the drawing) mounted on the vehicle is provided with two transmitter-receiver units that execute the data communication by using the power line Ld.

These different points will now be chiefly described.

Referring to FIG. 12, the battery ECU 260 is constituted chiefly by the microcontroller 262 like the other ECUs and is provided on the power line Ld that is running from the battery 250 to all of the electric loads inclusive of other ECUs.

The battery ECU 260 includes a first transmitter-receiver unit 264 for communicating the data with the other ECUs inclusive of the control ECU 270 through the communication line Ln, a filter unit 265 for picking up the DC voltage and the high-frequency signal components for data communication from the power line Ld, a power unit 267 for forming a constant DC voltage Vcc for operating the circuit in the battery ECU 260 from the DC voltage picked up by the filter unit 265, a second transmitter-receiver unit 266 for communicating the data with other ECUs through the filter unit 265 and the power line Ld, a judging unit 268 which obtains, through the transmitter-receiver units 264, 266, the important data transmitted from the microcontroller 262 to the transmitter-receiver units 264, 266, compares these data, and judges whether the important data are normally output to the transmitter-receiver units 264, 266, and a battery load sensor 269 for detecting the load current flowing into the power line Ld and the battery voltage.

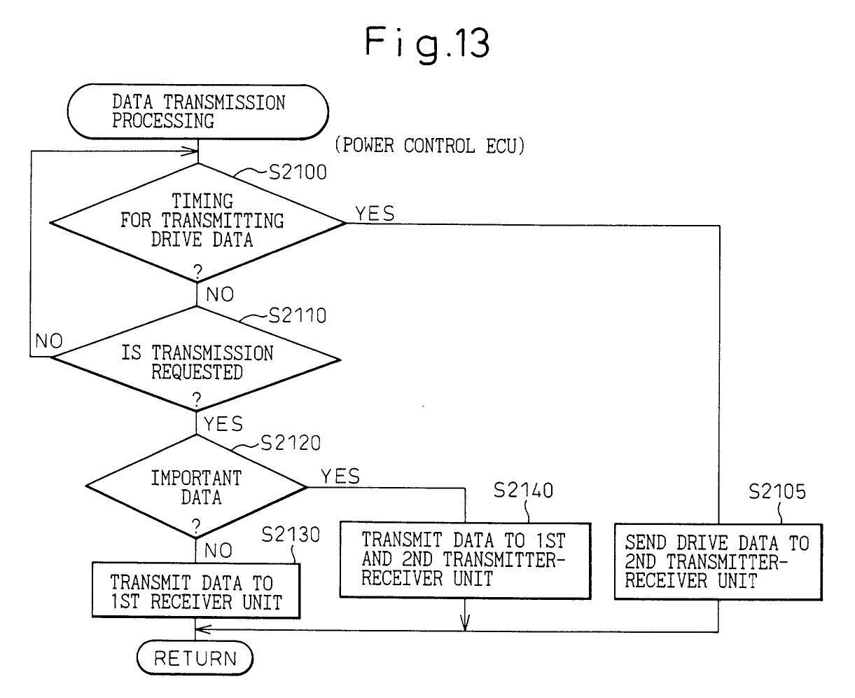

The microcontroller 262 executes the data transmission processing shown in FIG. 13 to transmit predetermined drive data to the second transmitter-receiver unit 266 at a predetermined transmission timing to drive the three-phase motor 290 that is to be controlled maintaining a minimum amount of control quantity even in case the microcontroller 272 constituting the ECU 270 fails to operate normally.

Namely, the microcontroller 262 judges at S2100 whether it is now the timing for transmitting a preset drive data. When it is not the timing for transmitting the drive data, the microcontroller 262 at S2110 executes other arithmetic processings to judge whether it has been requested to transmit the data to the other ECUs. When it has not been requested to transmit the data, the routine returns back to S2100 to wait for the request for transmitting the drive data or the request for transmitting other data. When it is judged at S2100 that it is now the timing for transmitting the drive data, the routine proceeds to S2105 to transmit the drive data to the second transmitter-receiver unit 266. Then, the data for driving the three-phase motor 290 is transmitted from the second transmitter-receiver unit 266 onto the power line Ld. When it is judged at S2110 that it has been requested to transmit other data, the data transmission processing similar to the data transmission processing shown in FIG. 9, is executed through S2120 to S2140.

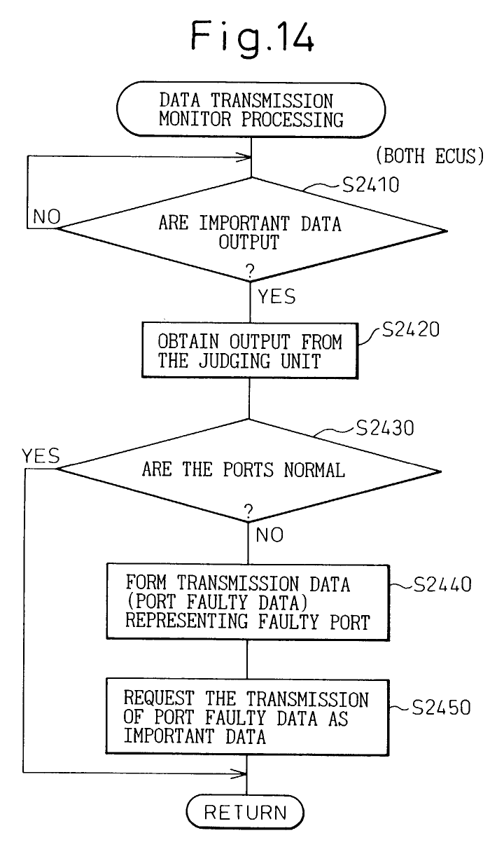

When the microcontroller 262 has output important data to the transmitter-receiver data units 264, 266 through the data transmission processing of S2140, a data transmission monitor processing shown in FIG. 14 is executed.

In the data transmission monitor processing, first, it is judged at S2410 whether the important data are transmitted to the transmitter-receiver units 264, 266, and the request for transmitting the important data to the transmitter-receiver units 264, 266 is waited for. When the important data are transmitted to the transmitter-receiver units 264, 266, the result judged by the judging unit 268 is obtained at S2420. By relying upon the result of judgement, it is judged at S2430 whether the output ports are normally connected to transmit the data to the transmitter-receiver units 264, 266 from the microcontroller 262. When the ports are normal, the processing ends. Conversely, when it is judged that either port is faulty, a transmission data (port faulty data) is formed at S2440 to represent a port that is faulty. At S2450, then, it is requested to transmit the port faulty data as important data, and the processing ends.

Therefore, the processing of S2450 is executed in case the ports are disconnected between, for example, the microcontroller 262 and the first transmitter-receiver unit 264 or the second transmitter-receiver unit 266 and the data can be transmitted to none of the transmitter-receiver units. On the data transmission side, a processing (S2140) is executed for transmitting the port faulty data to the transmitter-receiver units 264 and 266, and the port faulty data is transmitted onto the communication line Ln or the power line Ld from the first transmitter-receiver unit 264 or the second transmitter-receiver unit 266 whichever is capable of normally transmitting the data.

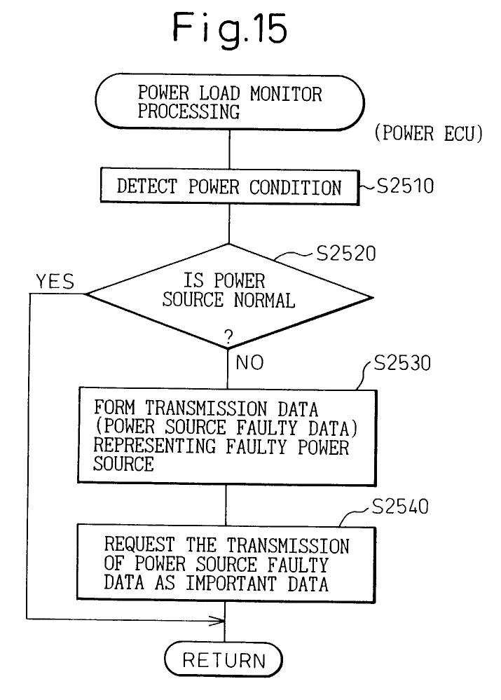

In addition to the above processings, the microcontroller 262 executes the power load monitor processing shown in FIG. 15. In the power load monitor processing, first, a load current and a battery voltage detected by the battery load sensor 269 are obtained at S2510. At a subsequent S2520, it is judged whether the power source is normal or, if described in detail, whether the data communication can be normally conducted by using the power line Ld based on the load current and the battery voltage that are obtained. When it is judged at S2520 that the power source is normal, the processing ends. Conversely, when it is judged at S2520 that the power source has failed, the routine proceeds to S2530 to form transmission data (power source faulty data) representing faulty power source. At S2540, a request is made to transmit the power faulty data as important data, and the processing once ends.

Namely, the load current flowing into the power line Ld and the battery voltage may greatly vary as the electric loads are turned on or off. A change in the load makes it difficult to maintain favorable data communication by using the power line Ld. In this embodiment, therefore, it is judged at S2520 whether the data communication by using the power line Ld can be normally conducted in the power source state detected by the battery load sensor 269. When the power source has failed, a power source faulty data representing this fact is transmitted as important data to the other ECUs.

When the request is made to transmit the power source faulty data at S2540, a processing is executed on the data transmission side to transmit the power source faulty data as important data to the transmitter-receiver units 264, 266, and the power source faulty data is transmitted from the first transmitter-receiver unit 264 and the second transmitter-receiver unit 266 onto the communication line Ln and the power line Ld. In this case, it is not allowed, in many cases, to normally conduct the data communication by using the power line Ld. Therefore, the power faulty data is transmitted to the other ECUs through the communication line Ln.

Like the battery ECU 260, the control ECU 270, too, is provided with a microcontroller 272, a first transmitter-receiver unit 274, a filter unit 275, a power unit 277, a second transmitter-receiver unit 276 and a judging unit 278, as well as with a motor drive unit 280 for driving a three-phase motor 290 that is to be controlled.

The microcontroller 272 executes a control quantity operation processing that is not shown, detects a rotational speed or a rotational position of the three-phase motor 290 through the rotation sensor 292 provided in the three-phase motor 290 that is to be controlled by the microcontroller, operates the drive data for driving and controlling the three-phase motor 290 so as to accomplish a target value as calculated based upon the data obtained from the other ECUS through the first transmitter-receiver unit 274 or the second transmitter-receiver unit 276 and upon the data detected by sensors which are not shown, and sends the drive motor to the motor drive unit 280.

When the important data are output to the transmitter-receiver units 274, 276 so as to be transmitted to the other ECUs, further, the microcontroller 272 executes a data transmission monitor processing (FIG. 14) that will be described later like the microcontroller 262 in the battery ECU 260, and judges, through the judging unit 278, whether the important data are normally transmitted to the transmitter-receiver units 274 and 276. In case the transmission has failed, the data representing this fact is transmitted as important data to the transmitter-receiver units 274 and 276, so that the data is transmitted from the transmitter-receiver unit 274 or 276 whichever is capable of normally producing the important data. The data transmission processing is executed by the microcontroller 272 according to the procedure shown in FIG. 9 like the ECUs of the second embodiment.

Next, the motor drive unit 280 includes an inverter 282 for controlling the electric currents that flow into the phase windings of the three-phase motor 290 based on detection signals from the current sensors 289 that detect the electric currents flowing into the phase windings of the three-phase motor 290 and the drive data for the three-phase motor input from an external unit, a serial communication unit 284 for receiving the drive data from the microcontroller 272, a filter unit 285 for picking up high-frequency signal components for data communication from the power line Ld, a second transmitter-receiver unit 286 for communicating the data with the other ECUs through the filter unit 285 and the power line Ld, and a selector 288 which judges whether the microcontroller 272 is normally operating based upon a signal (e.g., a watch-dog timer signal) regularly output from the microcontroller 272, sends the drive data which the serial communication unit 284 has received from the microcontroller 272 to the inverter 282 when the microcontroller 272 is normally operating, and sends the drive data for the three-phase motor 290 received through the second transmitter-receiver unit 286 to the inverter 282 when the microcontroller 272 is not normally operating (e.g., when the microcontroller 272 has failed).

Namely, the motor drive unit 280 is provided with the second transmitter-receiver unit 286 for receiving the drive data for the three-phase motor 290 regularly transmitted from the battery ECU 260. When the microcontroller 272 has failed to normally operate, the selector 288 judges this fact and enables the three-phase motor 290 to be driven by the drive data from the battery ECU 260.

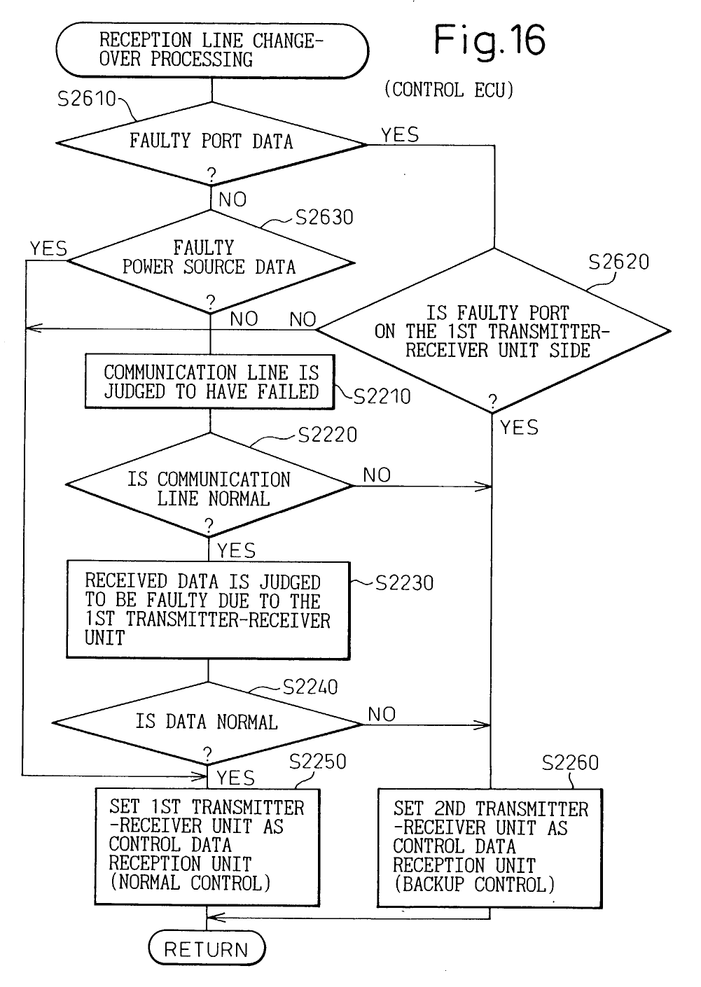

Next, FIG. 16 illustrates a reception line change-over processing executed by the control ECU 270.

The reception line change-over processing basically executes S2210 to S2260 as the reception line of the second embodiment shown in FIG. 10. In carrying out this processing, it is judged whether a port faulty data or a power source faulty data is transmitted from the battery ECU 260. When these data are transmitted, a control data receiving unit is set for preferentially obtaining the received data based upon the transmitted data.

Namely, in the reception line change-over processing, first, it is judged at S2610 whether the port faulty data is received by either the first transmitter-receiver unit 274 or the second transmitter-receiver unit 276. When the port faulty data is received, it is judged at S2620 whether the port on the side of the first transmitter-receiver unit (i.e., on the side of the communication line Ln) is faulty or the port on the side of the second transmitter-receiver unit (i.e., on the side of the power line Ld) is faulty in the ECU which has transmitted the data. When the port on the side of the first transmitter-receiver is faulty, it is not allowed to use its own first transmitter-receiver unit 274 for the data communication with the ECU. Therefore, the routine proceeds to S2260 to set the second transmitter-receiver unit 276 as the control data receiver unit for receiving, as control data, the data transmitted from the ECU that has transmitted the port faulty data. When the port on the side of the second transmitter-receiver unit is faulty, on the other hand, the routine proceeds to S2250 to set the first transmitter-receiver unit 274 as the control data receiver unit for receiving, as control data, the data transmitted from the ECU that has transmitted the port faulty data.

On the other hand, when it is judged at S2610 that the port faulty data has not been received, the routine proceeds to S2630 where it is judged whether the power source faulty data is received by either the first transmitter-receiver unit 74 or the second transmitter-receiver unit 76 from the battery ECU 260. When the power source faulty data has been received, it is not allowed to normally communicate the data by using the power line Ld. Therefore, the routine proceeds to S2250 to set the first transmitter-receiver unit 274 as the control data receiver unit for receiving, as control data, the data transmitted from all ECUs. When the power source faulty data has not been received, on the other hand, there is executed the reception line change-over processing of under normal condition subsequent to S2210.

The reception line change-over processing shown in FIG. 16 is similarly executed even by the other ECUs connected to the communication line Ln.

In the vehicle communication system according to the third embodiment as described above, the drive data which are at least required for operating the three-phase motor 290 are transmitted from the battery ECU 260 through the power line Ld. On the side of the control ECU 270, the three-phase motor 290 is driven by using these drive data when the microcontroller 272 has failed to normally operate. According to this embodiment, therefore, the three-phase motor 290 that is to be controlled is operated based on the important data transmitted through the power line Ld not only when the main data communication using the communication line Ln has failed but also when the microcontroller 272 in the control ECU 270 has failed, contributing to improving stability when the vehicle is travelling.

According to the third embodiment, further, the battery ECU 260 monitors the state of feeding the electric power from the power line Ld to the electric load, judges whether the data communication can be normally conducted through the power line Ld despite of change in the electric load, and transmits the judged result to the other ECUs. On the side of the other ECUs, it is determined whether the data received by using the power line Ld be used for the control operation depending upon the result of judgement. When the data communication cannot be normally conducted by using the power line Ld, therefore, the second transmitter-receiver unit on the side of the power line Ld is prevented from being erroneously set as the control data receiver unit.

Further, the third embodiment is provided with judging units 268, 278 which compare the important data input to the first transmitter-receiver units 264, 274 and to the second transmitter-receiver units 266, 276 that are provided for transmitting the important data in two systems, and judge whether the ports for transmitting the data from the microcontrollers 262, 272 to the transmitter-receiver units are faulty. When the ports are faulty, the data representing this fact is transmitted to the other ECUs, so that the other ECUs will not set the transmitter-receiver unit of the side where the port is faulty as the control data receiver unit. Thus, the data communication is normally conducted even in case the ports connecting the microcontrollers to the transmitter-receiver units are disconnected due to vibration occurring in the car body.

In the third embodiment, the control ECU 270 corresponds to the second control unit described in claim 14 or claim 25, the microcontroller 272 corresponds to the operation means described in claim 14 or claim 25, the inverter 82 corresponds to the drive means described in claim 14 or claim 25, the second transmitter-receiver unit 286 corresponds to the drive data receiver means described in claim 14 or claim 25, and the selector 288 corresponds to the drive data change-over means described in claim 14 or claim 25. Further, the battery ECU 260 corresponds to the power source monitoring device described in claim 16 or claim 22, the judging units 268, 278 correspond to the failure-in-the-path judging means described in claim 19 or claim 28, and the data transmission monitor processing (FIG. 14) works as the failure-in-the-path notifying means described in claim 19 or claim 28.

Therefore, the vehicle communication system according to the third embodiment is the one to which the invention described in claim 14 or claim 25 is applied. Here, for example, the first transmitter-receiver unit 274, the second transmitter-receiver unit 276 and the judging unit 278 may be removed from the control ECU 270 of this embodiment, and the microcontroller 272 may operate the data for driving the three-phase motor 290 by using the data obtained from the sensors connected through the dedicated signal lines. This control ECU that is connected to the power line Ld represents the first control unit described in claim 13 or claim 24. The vehicle communication system equipped with this control ECU is the one to which the invention of claim 13 or claim 24 is applied. In this vehicle communication system, too, when the microcontroller constituting the control ECU has failed, the actuator such as the three-phase motor or the like is driven by using the drive data transmitted from the other ECUs though the power line Ld maintaining improved safety when the vehicle is traveling like the vehicle communication system of this embodiment.

[Fourth Embodiment]

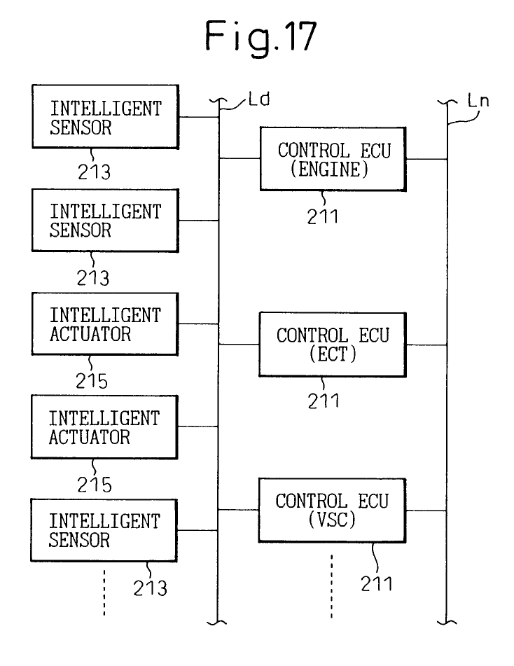

FIG. 17 is a block diagram illustrating the vehicle communication system according to a fourth embodiment to which the fourth aspect of the invention is applied.

According to the vehicle communication system of the fourth embodiment as shown in FIG. 17, the control ECUs 211 comprising the engine ECU, ECT ECU, VSC ECU and the like are connected together through the communication line Ln. Further, the sensors and actuators which have heretofore been connected to the control ECUS 211 through the dedicated signal line separately from the network of the control system built up on the vehicle, are replaced by intelligent sensors 213 and intelligent actuators 215 having a communication function. Then, a network (hereinafter referred to as power line network) using the power line Ld is built up between the intelligent sensors 213, intelligent actuators 215 and the control ECUs 211 while abolishing the signal lines used for individually connecting the sensors and actuators to the control ECUs.

Therefore, the control ECUs 211, intelligent sensors 213 and intelligent actuators 215 are provided with communication means for executing the data communication by using the power line Ld. According to this embodiment, the communication means works to transmit and receive the data simultaneously two times based on an FDMA system.

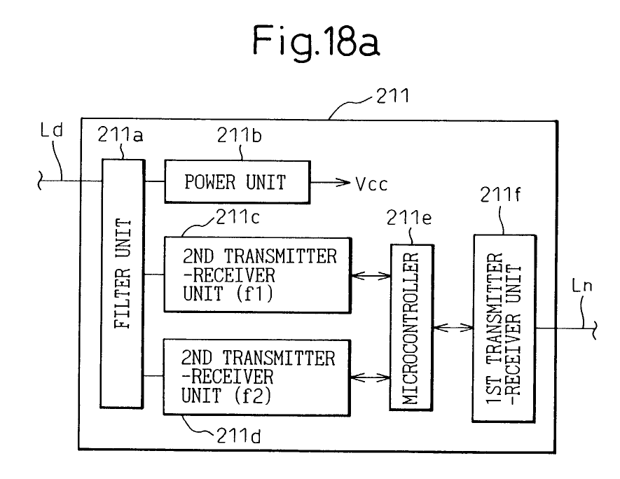

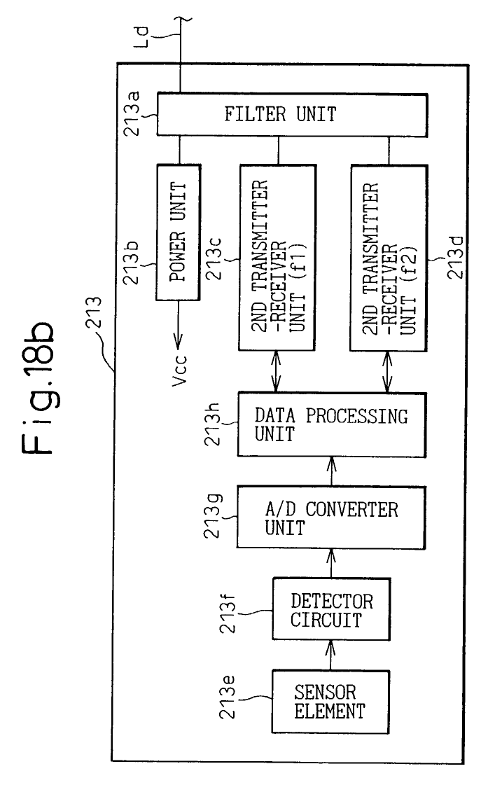

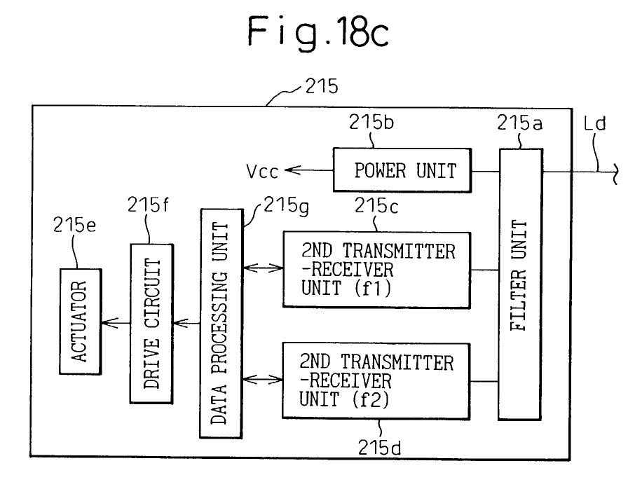

First, as shown in FIG. 18a, the control ECU 211 includes a microcontroller 211 for executing a variety of arithmetic processing, a first transmitter-receiver unit 211f for communicating the data with the other control ECUs 211 through the communication line Ln, a filter unit 211a for picking up a DC voltage and high-frequency signals of predetermined frequency bands (frequencies f1, f2 in this embodiment) from the power line Ld, a power unit 211b for forming a constant DC voltage Vcc for operating the circuits in the control ECU 211 from the DC voltage taken out through the filter unit 211a, and a pair of second transmitter-receiver units 211c and 211d for communicating the data through the power line Ld by using carrier waves of different frequencies f1 and f2.

The microcontroller 211e receives the detection data transmitted from the intelligent sensors 213 through the second transmitter-receiver units 215c, 215d, and judges whether the detection data are in agreement, or judges which data is normal when they are not in agreement. The microcontroller 211e selects the detection data which is normal, operates the drive data for the actuator that is to be controlled based on the selected detection data and the data received from the other ECUs through the first transmitter-receiver unit 211f, and sends the drive data onto the power line Ld through the second transmitter-receiver units 215c and 215d.

Like the control ECU 211, the intelligent sensors 213 and intelligent actuators 215, too, are provided, as shown in FIGS. 18b and 18c, with filter units 213a, 215a, power units 213b, 215b, and pairs of second transmitter-receiver units 213c, 213d, 215c, 215d.

The intelligent sensor 213 further includes a detector circuit 213f for obtaining a detection signal from the sensor element 213e, an A/D converter unit 213g for converting the detection signal from the detector circuit 213f into a digital data, and a data processing unit 213h which sends the digital data (detection data) put to the A/D conversion through the A/D converter unit 213g to the second transmitter-receiver units 213c, 213d at a predetermined transmission timing to transmit the detection data to the control ECU 211 through the power line Ld.

The intelligent actuator 215 further includes a data processing unit 215g which obtains, through the second transmitter-receiver units 215c, 215d, the drive data transmitted to its own actuator 215e from the control ECU 211, judges whether the drive data are in agreement, or judges which data is normal when they are not in agreement, selects the drive data which is normal, and sends the selected drive data to the drive circuit 215f which drives the actuator 215e based on the drive data sent from the data processing unit 215g.

According to the fourth embodiment as described above, a power line network is built up by using the power line Ld among the control ECUs, sensors and actuators, and the detection data and the drive data are transmitted and received twice relying upon the simultaneous multiplex communication through the power line network.

According to the vehicle communication system of this embodiment, therefore, even when the noise is superposed on the power line Ld, the data can be communicated by using the second transmitter-receiver unit of the side that is not affected by noise owing to the simultaneous multiplex communication of the same data though it is not allowed to communicate the data when the power line is broken or short-circuited.

In this embodiment, each ECU is provided with a pair of second transmitter-receiver units for executing the data communication by using carrier waves of frequencies f1 and f2. However, the ECU may be provided with three second transmitter-receiver units, and may take a majority of data obtained through the three second transmitter-receiver units at the time of selecting the data received by the data processing unit 215g by using the microcontroller 211e in the control ECU 211 or by using the intelligent actuator 215, in order to select a normal data that is received.

In the fourth embodiment, the pair of second transmitter-receiver units provided in each ECU correspond to the communication means of the fourth aspect of the invention, and the selection processing for receiving the data executed by the microcontroller 211e and the data processing unit 215g provided in the control ECU 211 and in the intelligent actuator 15, corresponds to the selection means of the fourth aspect of the invention.

[Fifth Embodiment]

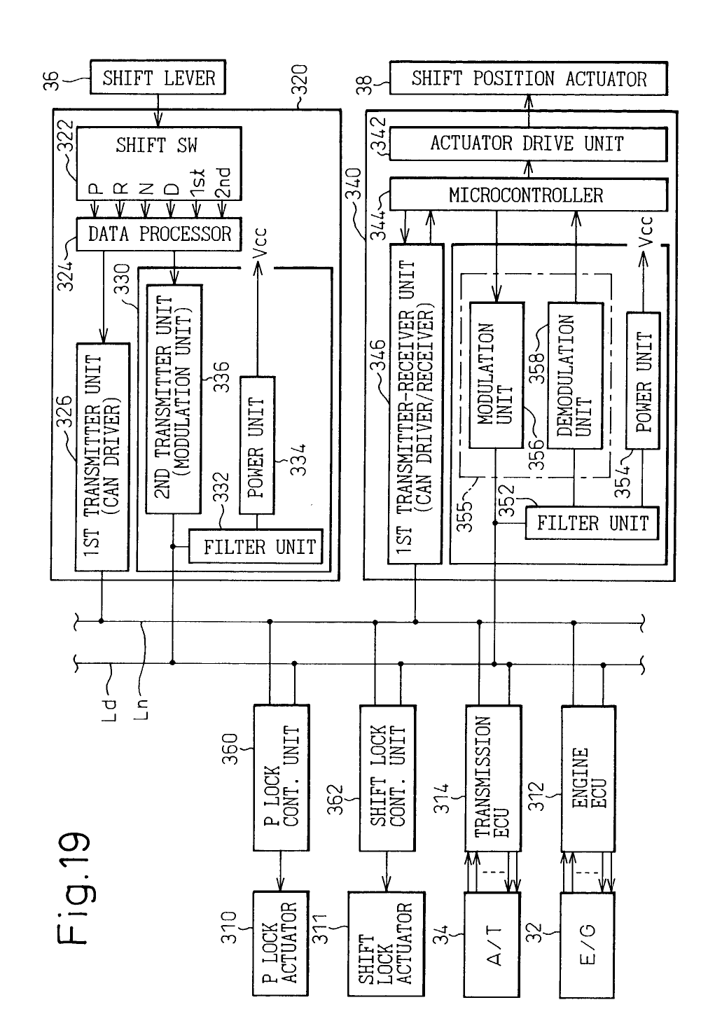

FIG. 19 is a diagram schematically illustrating the constitution of the communication system according to an embodiment (hereinafter referred to as fifth embodiment) in the vehicle drive system to which the fifth aspect of the invention is applied.

Referring to FIG. 19, the communication system according to the fifth embodiment is constituted by electric devices that have heretofore been provided for the vehicle drive system, such as an engine control unit (called engine ECU) 312 for controlling an engine (E/G) 32 which is a prime mover of a vehicle (an automobile in this embodiment) and a transmission control unit (transmission ECU) 314 for changing over the transmission gear ratio (or, in other words, a speed-change gear position) of an automatic transmission (A/T) 34 which transmits the power from the engine 32 to the drive wheels depending upon the operating conditions of the vehicle, as well as a shift position instruction detector unit 320 that constitutes the shift-by-wire system, a shift position control unit 340, a P lock (parking lock) control unit 360 and a shift lock control unit 362.

These devices are connected together through the communication line Ln dedicated to the data communication and the power line Ld for feeding the electric power from the battery that is not shown to the devices. In the communication system of this embodiment, the communication line Ln is used as a first communication line of the fifth aspect of the invention in order to exchange the data among all of the devices, and the power line Ld is used as a second communication line of the fifth aspect of the invention in order to exchange (backup communication) the predetermined important data only among the data exchanged among the devices.

Here, the shift position instruction detector unit 320 includes a shift switch 322 for detecting the operation position (P, R, N, D, 1st, 2nd, etc.) of the shift lever 36 operated by the driver, a data processing unit 324 which receives the operation position of the shift lever 36 detected by the shift switch 322 as a shift position instruction of the automatic transmission 34, converts it into a transmission data, and transmits the data at a predetermined transmission timing, a first transmission unit 326 for transmitting the data output from the data processing unit 324 to the other control devices constituting the communication system through the communication line Ln, and a power IC 330 connected to the power line Ld.

The power IC 330 is constituted by a filter unit 332 which receives a DC voltage fed from a battery that is not shown through the power line Ld and removes high-frequency signal components for data communication flowing into the power line Ld, a power unit 334 for forming a constant DC voltage Vcc for operating the internal circuits in the shift position instruction detector unit 320 from the DC voltage that has passed through the filter unit 332, and a second transmitter-receiver unit (in other words, a modulation unit) 336 which forms a transmission signal by modulating the carrier waves according to the transmission data output from the data processing unit 324 and superposes the signal on the power line Ld.

In the fifth embodiment, the data communication uses the communication line Ln based upon the CAN (“controller area network” proposed by Robert Bosch Co, Germany) which is a protocol generally used in the car-mounted network.

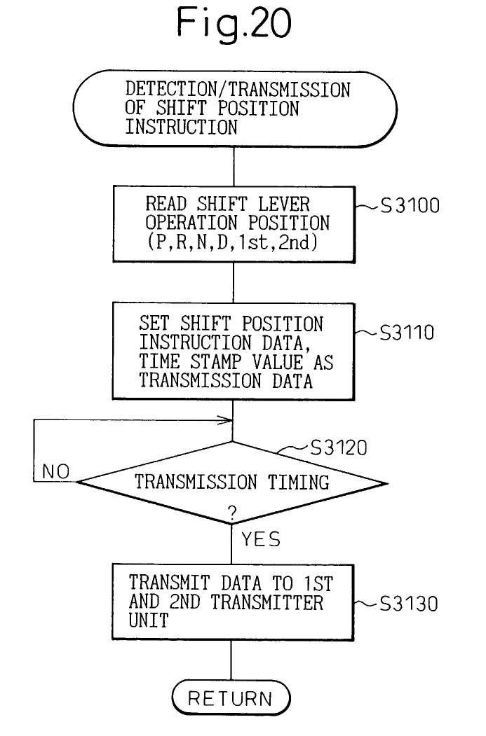

Referring to FIG. 20, the data processing unit 324 reads the operation position of the shift lever 36 detected by the shift switch 322 (S3100), imparts a time stamp value representing the present time thereto with the operation position that is read as a shift position instruction data (S3110) and, then, waits for a predetermined transmission timing at which it is permitted to transmit the data from the device (S3120). At the transmission timing, the data processing unit 324 transmits the data to the first transmission unit 326 and to the second transmission unit 336 (S3130), and the routine returns to S3100 again. The shift position instruction is detected and transmitted according to the above procedure.

Accordingly, the shift position instruction detector unit 320 transmits the shift position instruction data to the other control devices through the power line Ld and the communication line Ln. Namely, the shift position instruction data is transmitted as important data to the other control devices.

In the fifth embodiment, the shift lever 36 corresponds to the operation unit of the fifth aspect of the invention, the first transmission unit 326 corresponds to the first transmission means of the fifth aspect of the invention, the second transmission means corresponds to the second transmission means of the fifth aspect of the invention, the shift switch 322 corresponds to the detector means of the fifth aspect of the invention, and the data processing unit 324 corresponds to the shift position instruction transmission control means according to the fifth aspect of the invention.

Next, the shift position control unit 340 sets an optimum shift position of the automatic transmission 34 based upon the shift position instruction data transmitted from the shift position instruction detector unit 320 and upon the data representing the operating conditions of the vehicle (engine rotational speed, vehicle speed, position of the speed change gear) transmitted from the engine ECU 312 and the transmission ECU 314. The shift position control unit 340, then, controls the shift position of the automatic transmission 34 according to the thus set optimum shift position.

That is, the shift position control unit 340 is constituted by an actuator drive unit 342 for driving a shift position actuator 38, a microcontroller 344 which is an operation means which operates an optimum shift position of the automatic transmission 34 and causes the actuator drive unit 342 to drive the shift position actuator 38, a first transmitter-receiver unit 346 for communicating the data with the other control devices through the communication line Ln, and a power IC 350 connected to the power line Ld.

The power IC 350 is constituted by a filter unit 352 which picks up the DC voltage fed from the battery that is not shown through the power line Ld and high-frequency signal components for data communication flowing in the power line Ld, a power unit 354 for forming a constant DC voltage Vcc for operating the internal circuits in the device from the DC voltage from which the high-frequency signal components have been removed by the filter unit 352, and a second transmitter-receiver unit 355 for communicating the data with the other control devices through the power line Ld. Further, the second transmitter-receiver unit 355 is constituted by a modulation unit 356 which forms a transmission signal by modulating the carrier wave used for the data communication based upon the transmission data output from the microcontroller 344 and superposes it on the power line Ld, and a demodulation unit 358 which receives the high-frequency signal components for data communication picked up by the filter unit 352 to demodulate them into the received data.

The first transmitter-receiver unit 346 is constituted by a CAN driver/receiver for effecting the data communication by using the communication line Ln in compliance with the CAN protocol.

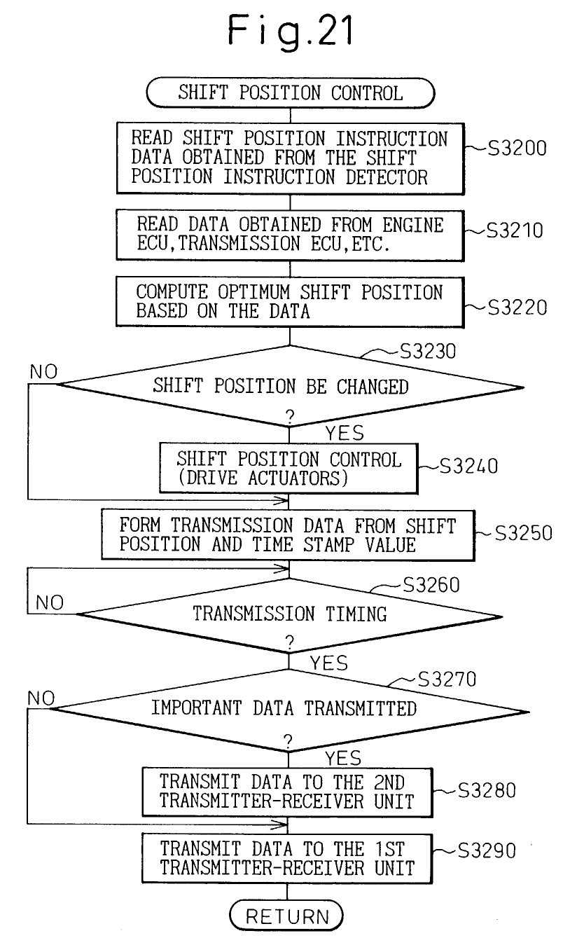

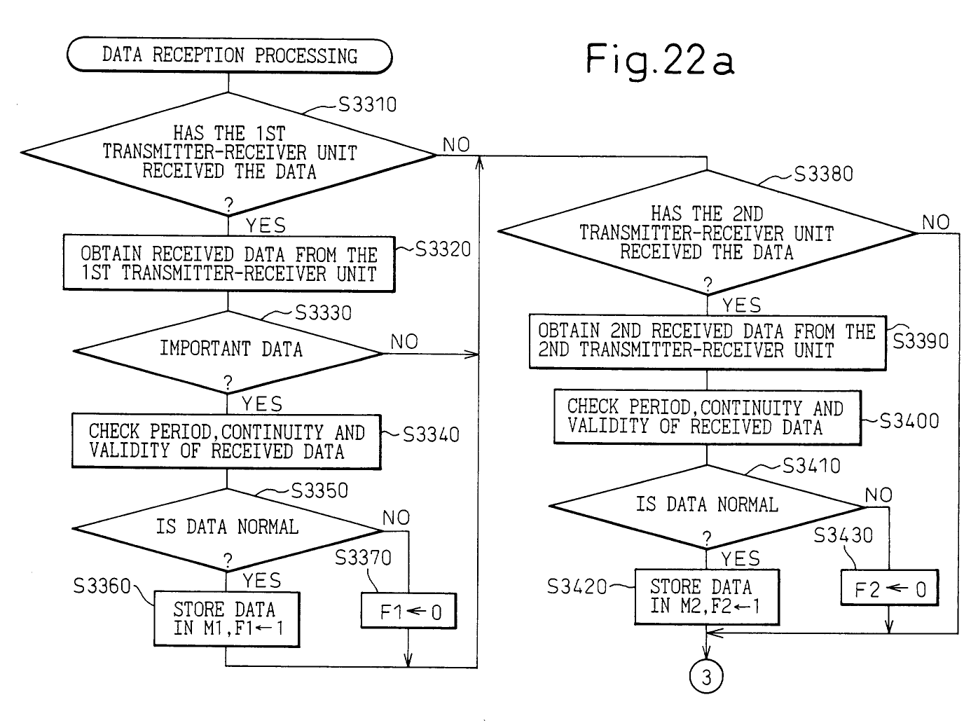

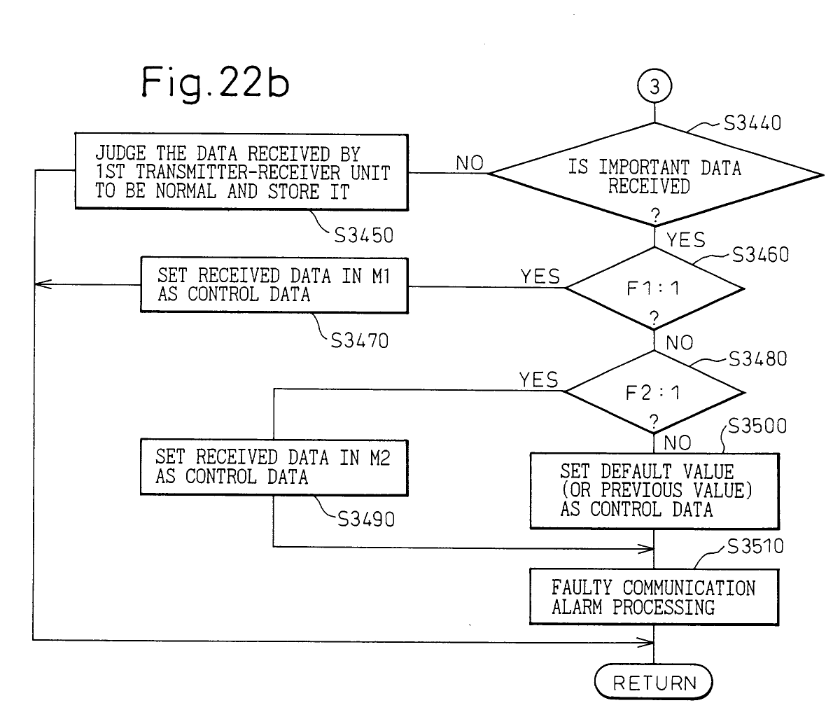

The microcontroller 344 controls the shift position according to a procedure illustrated in FIG. 21, and obtains the data transmitted to the shift position control unit 340 from the other control devices according to a procedure shown in FIG. 22. These control processes will now be described.

In the shift position control processing as illustrated in FIG. 21, first, the microcontroller 344 reads at S3200 the shift position instruction data from the shift position instruction detector unit 320 obtained by a data reception processing (FIG. 22) described later. Then, at S3210, the microcontroller 344 reads the data representing the operating conditions of the vehicle obtained from the other control devices such as the engine ECU 312 and transmission ECU 316 in the data reception processing that will be described later. Then, at S3220, an optimum shift position of the automatic transmission 34 is operated based upon the data read at S3200 and S3210. Then, at S3230, it is judged whether the present shift position is an optimum shift position thereby to judge whether the shift position of the automatic transmission 34 needs be changed.

When the present shift position is not the optimum shift position and, hence, the shift position of the automatic transmission 34 needs be changed, the shift position actuator 38 is driven at S3240 through the actuator drive unit 342 to bring the shift position of the automatic transmission 34 to the optimum shift position, and the routine proceeds to S3250. When the shift position of the automatic transmission 34 does not need be changed, on the other hand, the routine proceeds to S3250.

At S3250, transmission data is formed by imparting a time stamp value representing the present time to the present shift position in order to transmit the present shift position of the automatic transmission 34 to the other control devices. Then, at subsequent S3260, a predetermined transmission timing at which it is allowed to transmit the data from the device is waited for.

At the transmission timing, it is judged at S3270 whether the data to be transmitted this time is a predetermined important data. When the transmission data is the important data, the data is transmitted at S3280 to the second transmitter-receiver unit 355 (or more closely, modulation unit 356), and the routine proceeds to S3290. Conversely, when the transmission data is not the important data, the routine proceeds to S3290. At S3290, the data is transmitted to the first transmitter-receiver unit 346, and the routine returns to S3200 again.

Therefore, when the transmission data formed at S3250 is the important data, the data is transmitted from the shift position control unit 340 to the other control devices through the power line Ld and the communication line Ln. The transmission data that is not important is transmitted to the other control devices through the communication line Ln.

In this embodiment, among the transmission data formed at S3250, the transmission data just after the shift position of the automatic transmission 34 is changed over by the process of S3240 is set as the important data. This transmission data only is transmitted to the other control devices through the networks of two systems comprising the power line Ld and the communication line Ln.

Next, the data reception processing shown in FIG. 22 is the one executed by either the first transmitter-receiver unit 346 or the second transmitter-receiver unit 355 (or closely, demodulation unit 358) when the data is transmitted from the other devices.

When the data reception processing starts, it is, first, judged at S3310 whether the first transmitter-receiver unit 346 has received data. When the first transmitter-receiver unit 346 has received the data, the data received by the first transmitter-receiver unit 346 is obtained at S3320, and it is judged at S3330 whether the received data is important or not.

When the received data is not important, the routine proceeds to S3380. When the received data is important, on the other hand, reliability of the received data is checked at S3340 by checking the period for receiving the data, continuity of the content of data from the past data and validity of the content of data, and the routine proceeds to S3350.

At S3350, it is judged whether the received data is normal having high reliability based on the result of checking the reliability of the received data at S3340. When the received data is normal, the routine proceeds to S3360 where the received data is stored in the memory region M1 in the microcontroller 344, the flag F1 for temporarily storing the checked result of reliability is set, and the routine proceeds to S3380. When the received data is not normal, on the other hand, the flag F1 is reset at S3370, and the routine proceeds to S3380.

The flag F1, and a flag F2 that will be described later, are initially reset at the start of the data reception processing.

Then, at S3380, it is judged whether the second transmitter-receiver unit 355 has received the data. When the second transmitter-receiver unit 355 has received the data, the data received by the second transmitter-receiver unit 355 is obtained at S3390, and reliability of the received data is checked at S3400 by checking the period for receiving the data, continuity of the content of data from the past data and validity of the content of data, and the routine proceeds to S3410.

At S3410, it is judged whether the received data is normal having high reliability based on the result of checking the reliability of the received data at S3400. When the received data is normal, the routine proceeds to S3420 where the received data is stored in the memory region M2 in the microcontroller 344, the flag F2 is set, and the routine proceeds to S3440. When the received data is not normal, on the other hand, the flag F2 is reset at S3430, and the routine proceeds to S3440.

At S3440, it is judged whether the data received this time by either one or both of the first transmitter-receiver unit 346 and the second transmitter-receiver unit 355 is important. When the received data is not important (or, in other words, when the data which is not important is received by the first transmitter-receiver unit 346), the routine proceeds to S3450 where it is judged whether the received data is normal by using a check code (e.g., CRC) imparted to the received data. When the data is normal, a processing is executed for judging the received data to be normal and for storing it as control data, and the process ends.

When it is judged at S3440 that the received data is important, it is, then, judged at S3460 whether the flag F1 has been set. When the flag F1 has been set, the important data received by the first transmitter-receiver unit 346 is normal. At S3460, therefore, the data is read out from the memory region M1 and is stored as important data for use in the control operation. The process, then, ends.

Next, when it is judged at S3460 that the flag F1 has been reset, i.e., when important data has not been received by the first transmitter-receiver unit 346 or when the important data received by the first transmitter-receiver unit 346 is faulty, it is judged at S3480 whether the flag F2 has been set. When the flag F2 has been set, the important data received by the second transmitter-receiver unit 355 is normal. At S3490, therefore, the data is read out from the memory region M2 and is stored as important data for use in the control operation. The routine, then, proceeds to S3510.

When it is judged at S3480 that the flag F2 has not been set, the important data received this time is faulty. Therefore, the routine proceeds to S3500 where the default value that has been set to the data in advance or the data value normally obtained in the previous time is set as important data received this time, and the routine proceeds to S3510.

Since the network constituted by at least the communication line Ln has now been failed, an alarm lamp provided in the compartment is turned on or an alarm sound is generated at S3510, i.e., faulty communication alarm processing is executed to notify the faulty state to a driver in the vehicle. The process, then, ends.

In the shift position control unit 340 as described above, both or either one of the first transmitter-receiver unit 346 and the second transmitter-receiver unit 355 receive the data from the other devices. When the received data is important, reliability of the received data is checked at S3330 and S3390 to judge whether the important data that is received is normal. The important data that is judged to be normal is used as the data for the control operation.

When it is judged, upon checking the reliability of the received data, that the important data that is received is not normal, the default value or the value of the previous time is set as the important data received this time. Besides, when the communication of important data through at least the communication line Ln has failed, this fact is notified to the driver.

As a result, it does not happen that the shift position instruction data, transmitted from the shift position instruction detector unit 320 to the shift position control unit 340 through the network of two systems, is not received by shift position control device 340. The shift position control device 340 controls the shift position of the automatic transmission 34 according to a shift position instruction input by the driver by operating the shift lever 36.

Therefore, the fifth embodiment maintains the reliability of the shift-by-wire system that is constituted by the shift position instruction detector device 320 and the shift position control unit 340 and, hence, maintains the safety of the vehicle.

In the fifth embodiment, the first transmitter-receiver unit 346 corresponds to the first communication means of the fifth aspect of the invention, the second transmitter-receiver unit 355 corresponds to the second communication means of the fifth aspect of the invention, the microcontroller 344 corresponds to the operation means of the fifth aspect of the invention, and the actuator drive unit 342 corresponds to the shift position change-over means of the fifth aspect of the invention. Among the processes executed by the microcontroller 344, further, the process at S3510 corresponds to the failure-in-communication notifying means of the fifth aspect of the invention, and the processes of S3330 and S3440 correspond to the reliability judging means of the fifth aspect of the invention.

Next, when a parking position instruction representing the operation position “P” of the shift lever 36 is transmitted as a shift position instruction data from the shift position instruction detector device 320, the P lock control device 360 judges whether the shift position of the automatic transmission 34 be locked based upon the vehicle operating conditions (engine rotational speed, vehicle speed, position of speed change gear, etc.) transmitted from the engine ECU 312 and the transmission ECU 314. When the P lock is possible, the P lock actuator 310 provided for the automatic transmission 34 is driven to lock the shift position of the automatic transmission 34.

The P lock control unit 360 is constituted in the same manner as the shift position control unit 340, effects the P lock control by using the microcontroller according to nearly the same procedure as the shift position control processing illustrated in FIG. 21, and further effects the data reception processing according to the same procedure as the data reception processing illustrated in FIG. 22.

Namely, in the P lock control unit 360, the actuator that is to be controlled is different from the shift position control unit 340, and the condition for driving the actuator is different. Therefore, though the contents of the processes executed at S3220 to S3250 illustrated in FIG. 21 are different, the procedure for transmitting and receiving the data to and from the other devices is the same as that of the shift position control unit 340.

Further, the shift lock control unit 362 prevents the vehicle from starting even though the shift lever 36 is erroneously operated as a result of securing (locking) the shift lever 36 at the position “P” via the shift lock actuator 311 when the shift lever 36 is operated to the position “P”.

The shift lock control device 362 is constituted in the same manner as the shift position control unit 340 or the P lock control unit and executes the data reception processing by using the microcontroller according to nearly the same procedure as the data reception process shown in FIG. 22. When it is detected by this data reception processing that a parking position instruction representing the operation position “P” of the shift lever 36 is transmitted from the shift position instruction detector unit 320, the shift lock actuator 311 is driven to lock the shift lever 36 at the position “P”. The shift lock is reset when, for example, the driver depresses the brake pedal (or, in other words, when the vehicle will not start undesirably even when the shift lock is reset).

According to the fifth embodiment, therefore, the P lock control by the P lock control unit 360 and the shift lock control by the shift lock control unit 362 are both reliable, as the shift position control by the shift position control unit 340, to maintain the safety of the vehicle.

The electric devices such as the engine ECU 312 and the transmission ECU 314 that have no direct relationship to the shift-by-wire system, are basically constituted in a customary manner. In this embodiment, however, even these portions incorporate the first transmitter-receiver unit 346 and the power IC 350 like the shift position control unit 340, and transmit and receive important data using the networks of two systems constituted by the communication line Ln and the power line Ld.

Therefore, the fifth embodiment improves reliability in the data communication among the electric devices as compared to the conventional communication system in the vehicle drive system built up by using the network of one system.

In the foregoing was described an embodiment according to the fifth aspect of the invention. The fifth aspect of the invention, however, is in no way limited to the above-mentioned fifth embodiment only but can assume a variety of modes.

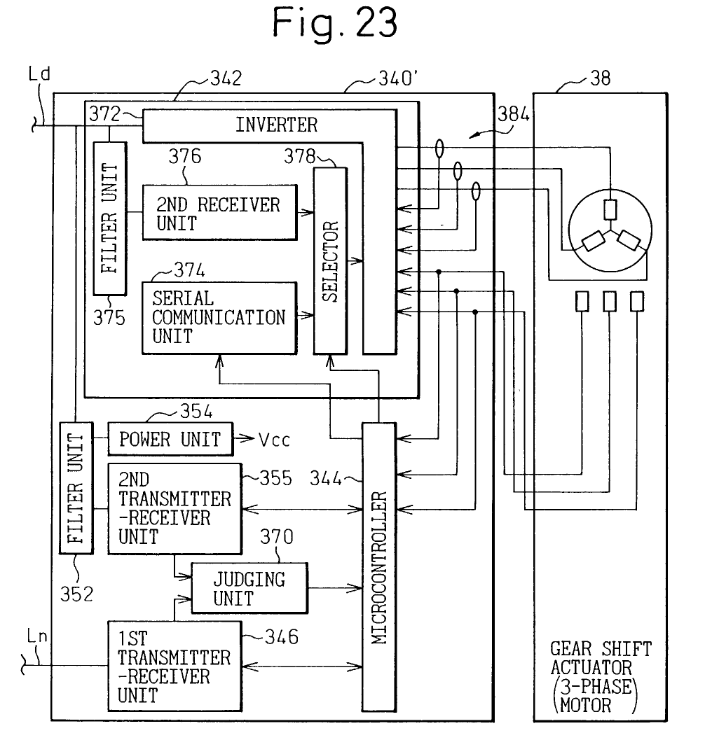

In the fifth embodiment, for example, the actuator drive unit 342 in the shift position control unit 340 drives the shift position actuator 38 according to a shift position change-over instruction directly input from the microcontroller 344. As shown in FIG. 23, however, a second receiver unit 376 may be provided in the actuator drive unit 342 to receive the data transmitted through the power line Ld, so that the actuator drive unit 342 may directly drive the shift position actuator 38 based on the data received by the second receiver unit 376 if the shift position change-over instruction is not received from the microcontroller 344 or if the microcontroller 344 becomes out of control.

Namely, the actuator drive unit 342 in the shift position control unit 340′ shown in FIG. 23 includes an inverter 372 for controlling the electric current flowing into the phase windings of a three-phase motor based upon the detection signals from the current sensors 384 for detecting the currents flowing into the phase windings of the three-phase motor constituting the shift position actuator 38 and upon the drive data input to the shift position actuator 38 from the microcontroller 344, a serial communication unit 374 for receiving the drive data from the microcontroller 344, a filter unit 375 for picking up high-frequency signal components for data communication from the power line Ld, a second receiver unit 376 for receiving, through the filter unit 375 and the power line Ld, the shift position instruction data that is transmitted from the shift position instruction detector unit 320 and for receiving the drive data sent to the power line Ld from the microcontroller 344 through the second transmitter-receiver unit 355 and filter unit 352 to drive the shift position actuator 38, and a selector 378 which selects either the drive data sent from the serial communication unit 374 or the data received by the second receiver unit 376, and sends the data to the inverter 372.

In executing the shift position control at S3240 in FIG. 21, the microcontroller 344 not only transmits the drive data as a shift position change-over signal to the actuator drive unit 342 but also sends the drive data to the second transmitter-receiver unit 355 to transmit the drive data from the second transmitter-receiver unit 355 onto the power line Ld through the filter unit 352.

In the actuator drive unit 342, the selector 378 monitors the operation of the microcontroller 344 based on the signals (e.g., watch-dog timer signal and time stamp signal) regularly output for monitoring the operation of the microcontroller 344. When the microcontroller 344 that is out of control is detected, the selector 378 changes the path for inputting the drive data to the inverter 372 from the side of the serial communication unit 374 over to the side of the second receiver unit 376, so that the shift position instruction data from the shift position instruction detector unit 320 received by the second receiver unit 376 is input to the inverter 372 as data for driving the shift position actuator 38.

Even when the microcontroller 344 is not out of control, the selector 378 changes the path for inputting the drive data to the inverter 372 from the side of the serial communication unit 374 over to the side of the second receiver unit 376 if no drive data is transmitted from the microcontroller 344 to the serial communication unit 374 for more than a predetermined period of time. In this case, the selector 378 selects the drive data from the microcontroller 344 received by the second receiver unit 376 and inputs it to the inverter 372.

According to the shift position control device 340′ illustrated in FIG. 23, therefore, the shift position actuator 38 is driven according to the shift position instruction data from the shift position instruction detector unit 320 or according to the drive data formed by the microcontroller 344 even when the microcontroller 344 runs out of control or the path for transmitting the drive data from the microcontroller 344 to the serial communication unit 374 has failed, further improving the reliability of the shift-by-wire system constituted by the shift position control unit 340′ and the shift position instruction detector unit 320.

In FIG. 23, when the microcontroller 344 has transmitted the important data to the first transmitter-receiver unit 346 and to the second transmitter-receiver unit 355, the judging unit 370 directly obtains the important data from the transmitter-receiver units 346, 355 that have received these data, and compares the important data to judge whether the important data have been normally output to the transmitter-receiver units 346, 355 from the microcontroller 344.

When it is judged by the judging unit 370 that the important data received by the transmitter-receiver units 346, 355 are not in agreement, the microcontroller 344 sends the data for notifying the failure representing this fact to the transmitter-receiver unit 346 or 355 that normally produces the important data to notify this fact to the other devices and, further, turns the alarm lamp in the compartment on or generates an alarm sound to notify this fact to the driver in the vehicle.

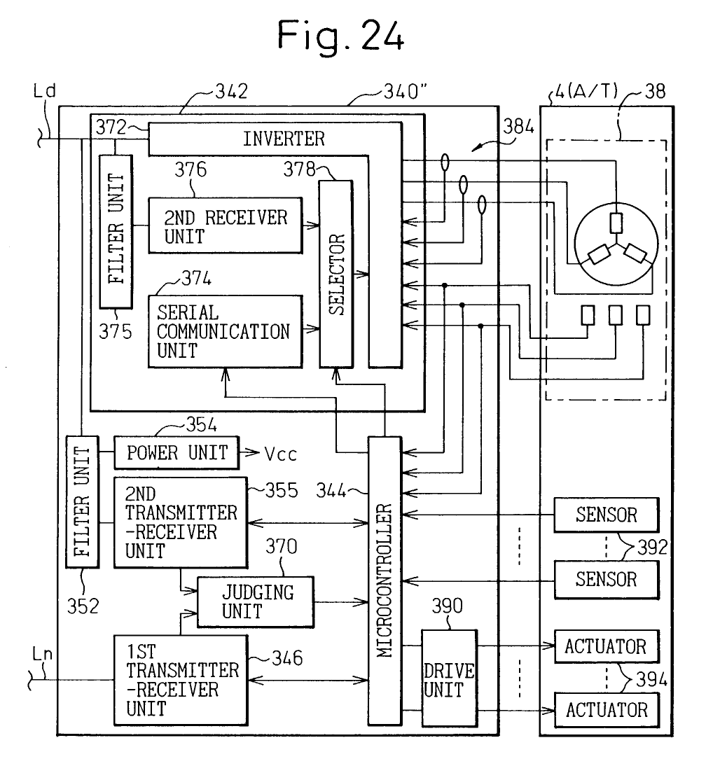

In the fifth embodiment, the shift position control unit 340 and the transmission ECU (transmission control unit) 314 are separately constituted, and are separately connected to the communication line Ln and to the power line Ld. As shown in FIG. 24, however, a drive unit 390 may be provided in the shift position control unit 340″ to drive the speed control actuator 394 in the automatic transmission 34, detection signals from the sensors 392 provided for the automatic transmission 34 may be input to the microcontroller 344, and the control processing may be executed to control the transmission. Then, it is possible to construct the shift position control unit 340 and the transmission ECU (transmission control unit) 314 as a unitary structure, to decrease the number of the elements (electric devices) constituting the communication system in building up the shift-by-wire system on a vehicle which mounts the automatic transmission, and to improve the workability of assembling the communication system on the vehicle.

In the above fifth embodiment, further, the shift position control unit 340 and the P lock control unit 360 are separately constituted. However, the P lock control unit 360 may be constructed integrally with the shift position control unit 340 or with the transmission ECU 314. All of them may be constituted as a unitary structure.

The second receiver unit 376 shown in FIGS. 23 and 24 corresponds to the second receiver means of the fifth aspect of the invention, and the drive unit 390 shown in FIG. 24 corresponds to the gear position change-over means of the fifth aspect of the invention.

1. A vehicle communication system equipped with a plurality of electric devices connected to a first communication line to execute data communication through the first communication line, wherein:
said first communication line is one arranged in a vehicle to feed the electric power to said electric devices; and
some of said electric devices are further connected as special electric devices to a second communication line, and the data communication among said special electric devices is executed through two systems of said first communication line and said second communication line.

2. A vehicle communication system according to claim 1, wherein said special electric devices execute at least either a process for transmitting an instruction data to said electric devices or a process for receiving and computing data of result from said electric devices.

3. A vehicle communication system according to claim 1, wherein the data communication among said special electric devices using said second communication line deals with predetermined important data only.

4. A vehicle communication system according to claim 1, wherein said special electric devices judge the reliability of data transmitted through said second communication line, use this data when the reliability thereof is higher than a predetermined reference, and use the data transmitted through said first communication line instead of using the data transmitted through said second communication line when the reliability is lower than the predetermined reference and when the data of the same content is transmitted also through said first communication line.

5. A vehicle communication system according to claim 1, wherein said special electric devices judge the reliability of data transmitted through said second communication line, use this data when the reliability thereof is higher than a predetermined reference, further judges the reliability of data transmitted through said first communication line when the reliability is lower than the predetermined reference and when the data of the same content is transmitted also through said first communication line, and use the data having a higher reliability of the data transmitted through said first communication line and through said second communication line.

6. A vehicle communication system according to claim 1, wherein said special electric devices that have received the data transmitted through both said first communication line and said second communication line, judge the reliability of the data, and use the data having higher reliability.

7. A vehicle communication system according to claim 1, wherein, when the data transmitted through said two communication lines are both determined to have a reliability lower than the predetermined reference, said special electric devices use the data stored in advance or the data transmitted in the past instead of using the data having low reliability.

8. A vehicle communication system according to claim 1, wherein, when the data transmitted through said two communication lines are both determined to have a reliability lower than the predetermined reference, said special electric devices instruct the source of transmitting the data to transmit the data again.

9. A vehicle communication system according to claim 1, wherein said special electric devices judge the reliability of said received data relying at least upon any data error detection code, a period for receiving the data, a continuity of data content from the data received in the past and a validity of data content.

10. A vehicle communication system according to claim 1, wherein said special electric devices indicate a fault in the data received, through said communication lines, to an external unit.

11. A vehicle communication system in which a plurality of electric devices mounted on the vehicle are provided with communication means for communicating the data through a communication line arranged in the vehicle to exchange the data among the electric devices, wherein each of said electric devices is provided with:
a plurality of communication means for communicating the same data using different communication lines; and
selection means for selecting normally received data out of a plurality of data received by using said plurality of communication means; and
wherein one of said plurality of communication means is a low-speed communication means for communicating the data at a speed slower than that of the other communication means, so that the data communication through said low-speed communication means exhibits higher reliability than that of the other communication means.

12. A vehicle communication system according to claim 11, wherein said slow-speed communication means transmits and receives predetermined important data only, from among the data transmitted and received by the other communication means, and said selection means selects the normal and important data out of the important data obtained by the plurality of communication means inclusive of said low-speed communication means.

13. A vehicle communication system according to claim 11, further comprising, as one of said electric devices, a first control unit having operation means for generating the data for driving an object that is to be controlled and drive means for driving the object that is to be controlled according to the drive data generated by said operation means, wherein:
said first control means includes:
drive data receiver means for receiving the data, for driving the object that is to be controlled, transmitted from the low-speed communication means of the other electric devices; and
drive data change-over means which monitors the operation of said operation means, inputs the drive data generated by said operation means to said drive means when said operation means is normally operating, and inputs the drive data received by said drive data receiver means to said drive means when the operation of said operation means is faulty.

14. A vehicle communication system according to claim 11, further comprising, as one of said electric devices, a second control unit having operation means for generating the data for driving an object that is to be controlled based upon the data obtained from the other electric devices through any one of said plurality of communication means and drive means for driving the object that is to be controlled according to the drive data operated by said operation means, wherein:
said second control means includes:
drive data receiver means for receiving the data for driving the object that is to be controlled transmitted from the low-speed communication means of the other electric devices; and
drive data change-over means which monitors the operation of said operation means, inputs the drive data operated by said operation means to said drive means when said operation means is normally operating, and inputs the drive data received by said drive data receiver means to said drive means when the operation of said operation means is faulty.

15. A vehicle communication system according to claim 11, wherein the communication line which the low-speed communication means uses for the data communication is the power line arranged in the vehicle to feed the electric power from the car-mounted power source to the electric devices.

16. A vehicle communication system according to claim 15, further comprising, as one of the electric devices, a power source monitoring device which monitors the state of feeding the electric power from the car-mounted power source to the car-mounted equipment inclusive of the electric devices, and transmits the monitored results to the other electric devices through the plurality of communication means inclusive of said low-speed communication means.

17. A vehicle communication system according to claim 11, wherein each of said electric devices includes a high-speed communication means as another communication means different from said low-speed communication means, and said selection means judges whether the data communication by said high-speed communication means is normal, and when the data communication by said high-speed communication means is normal, selects the data received through said high-speed communication means as data transmitted from the other electric devices, and when the data communication by said high-speed communication means has failed, selects the data received through said low-speed communication means as data transmitted from the other electric devices.

18. A vehicle communication system according to claim 11, wherein each of said electric devices includes a high-speed communication means which transmits and receives data the same as the data transmitted and received by said low-speed communication means a plural number of times in a time-divided manner, as another communication means different from said low-speed communication means, and said selection means selects normally received data out of said plurality of data that are received by taking a majority of the data received a plural number of times by said high-speed communication means and of the data received by said low-speed communication means.

19. A vehicle communication system according to claim 11, wherein at least one of said electric devices includes:
failure-in-the-path judging means for letting the plurality of communication means inclusive of said low-speed communication means receive the transmission data input to the other electric devices to judge whether the transmission data are normal, and for so judging, if the transmission of data has failed, that the path for inputting the transmission data to the failed communication means has failed; and
failure-in-the-path notifying means which, when it is judged by said failure-in-the-path judging means that the path for inputting the transmission data to any communication means has failed, sends the data expressing this fact as transmission data to the communication means of which the input path is normal, and notifies this fact to the other electric devices through said communication means.

20. A vehicle communication system provided with a plurality of car-mounted networks separately depending upon the functions and systems of said electric devices so as to transmit and receive the data among the electric devices by providing said electric devices mounted on the vehicle with first communication means for communicating the data among said electric devices through communication lines dedicated to the networks, wherein
each of the electric devices constituting said car-mounted networks comprises:
second communication means for transmitting and receiving, among the data transmitted and received to and from the other electric devices through said first communication means, the predetermined important data through a backup communication line which is common to the car-mounted networks arranged in the vehicle; and
selection means for selecting normal and important data out of the important data obtained through said first communication means and said second communication means.

21. A vehicle communication system according to claim 20, wherein the backup communication line which the second communication means uses for the data communication is the power line arranged in the vehicle to feed electric power from the car-mounted power source to the electric devices.

22. A vehicle communication system according to claim 21, further comprising, as one of the electric devices, a power source monitoring device which monitors the state of feeding electric power from the car-mounted power source to the car-mounted equipment inclusive of said electric devices, and transmits the monitored results as said important data to the other electric devices through said first communication means and said second communication means.

23. A vehicle communication system according to claim 20, wherein said second communication means transmits and receives said important data at a communication speed slower than that of said first communication means.

24. A vehicle communication system according to claim 20, further comprising, as one of said electric devices, a first control unit having operation means for generating the data for driving an object that is to be controlled and drive means for driving the object that is to be controlled according to the drive data generated by said operation means, wherein:
said first control means includes:
drive data receiver means for receiving, as said important data, the data for driving the object that is to be controlled transmitted from the second communication means of the other electric devices through said backup communication line; and
drive data change-over means which monitors the operation of said operation means, inputs the drive data generated by said operation means to said drive means when said operation means is normally operating, and inputs the drive data received by said drive data receiver means to said drive means when the operation of said operation means is faulty.

25. A vehicle communication system according to claim 20, further comprising, as one of said electric devices, a second control unit having operation means for generating the data for driving an object that is to be controlled based upon the data obtained from the other electric devices through said first communication means and said second communication means, and drive means for driving the object that is to be controlled according to the drive data operated by said operation means, wherein:
said second control means includes:
drive data receiver means for receiving, as said important data, the data for driving the object that is to be controlled transmitted from the second communication means of the other electric devices through said backup communication line; and
drive data change-over means which monitors the operation of said operation means, inputs the drive data generated by said operation means to said drive means when said operation means is normally operating, and inputs the drive data received by said drive data receiver means to said drive means when the operation of said operation means is faulty.

26. A vehicle communication system according to claim 20, wherein said selection means judges whether the data communication through said first communication means is normal, selects the data received through said first communication means as data transmitted from the other electric devices when the data communication through said first communication means is normal, and selects the data received through said second communication means as data transmitted from the other electric devices when the data communication by said first communication means has failed.

27. A vehicle communication system according to claim 20, wherein said first communication means is so constituted as to transmit and receive, a plural number of times, the important data transmitted and received by the second communication means, and the selection means takes a majority of the important data received by said first communication means a plural number of times and of the important data received by said second communication means, and selects normally received data out of the plurality of important data.

28. A vehicle communication system according to claim 20, wherein at least one of said electric devices includes:
failure-in-the-path judging means for letting said first communication means and said second communication means receive the transmission data input to the other electric devices as transmission data to judge whether the transmission data are normal, and for so judging, in case the transmission of data has failed, that the path for inputting the transmission data to the failed communication means has failed; and
failure-in-the-path notifying means which, when it is judged by said failure-in-the-path judging means that the path for inputting the transmission data to any communication means has failed, sends the data indicating this fact as transmission data to the communication means of which the input path is normal, and notifies this fact to the other electric devices through said communication means.

29. A vehicle communication system in which the electric devices mounted on the vehicle are provided with communication means for executing the data communication through the communication lines arranged in the vehicle to transmit and receive the data among the electric devices, and wherein said communication means transmits and receives the same data a plural number of time through the communication lines, and the electric devices are provided with selection means for selecting normally received data out of the plurality of data obtained after having been transmitted and received the plural number of times through said communication means.

30. A vehicle communication system according to claim 29, wherein said communication means transmits and receives the same data three or more times through said communication line, and said selection means takes a majority from three or more data received by said communication means to select a normally received data out of said three or more received data.

31. A vehicle communication system according to claim 29, wherein said communication means transmits and receives the same data a plural number of times by a time-division multiplex communication based upon TDMA, or a simultaneous multiplex communication based upon FDMA or CDMA.

32. A vehicle communication system according to claim 29, wherein said communication line is a power line arranged in the vehicle to feed the electric power from the car-mounted power source to the electric devices.

33. A vehicle communication system according to claim 29, wherein:
said electric devices are sensors for detecting the vehicle conditions, actuators for controlling the objects to be controlled and control units for driving the actuators by generating control quantities for controlling the objects to be controlled based upon detection signals from the sensors; and
said communication means is provided for each of the sensors, actuators and control units to thereby transmit the detection data from the sensors to the control units and to transmit the drive data from the control units to the actuators.

34. A communication system for a vehicle drive system in which electric devices in the vehicle drive system each include:
a shift position instruction detector unit provided in the operation unit that instructs the shift position of the transmission upon the external operation, in order to detect a shift position instruction input from said operation unit; and
a shift position control unit which sets an optimum shift position adapted to the vehicle based upon the shift position instruction detected by the shift position instruction detector means and upon the operating conditions of the vehicle, and changes the shift position of said transmission over to said optimum shift position;
are connected together through a first communication line for data communication, and at least said shift position control unit is allowed to obtain the shift position instruction and the operating conditions of the vehicle necessary for the shift position control operation from the other electric devices inclusive of said shift position instruction detector device by the data communication using said first communication line, wherein said electric devices are further connected together through a second communication line different from said first communication line, and at least said shift position instruction is transmitted from said shift position instruction detector device to the other electric devices through two systems comprising said first communication line and said second communication line.

35. A communication system for a vehicle drive system according to claim 34, wherein the second communication line is for transmitting and receiving the important data inclusive of said shift position instruction, and the electric devices except said shift position instruction detector unit transmit predetermined important data only among the transmission data to be transmitted to the other electric devices by using said first communication line and said second communication line of two systems, and transmit the other data by using said first communication line.

36. A communication system for a vehicle drive system according to claim 34, wherein said first communication line is the one dedicated to the data communication and said second communication line is the power line arranged in the vehicle for feeding electric power from the car-mounted power source to the electric devices.

37. A communication system for a vehicle drive system according to claim 34 wherein, when the data, that is to be transmitted through both said first communication line and said second communication line, is received through either one of these communication lines, the electric devices judge that the communication system of the other communication line has failed, and notify this fact to an external unit.

38. A communication system for a vehicle drive system according to claim 34, wherein, upon receipt of data transmitted through both said first communication line and said second communication line, the electric devices judge the reliability of data and employ the data having higher reliability as the received data.

39. A communication system for a vehicle drive system according to claim 38, wherein said electric devices judge the reliability of the received data relying upon at least one of the period for receiving the data, continuity of data content from the data received in the past and validity of the data content.

40. A shift position instruction detector unit used in a communication system for a vehicle drive system according to claim 34, comprising:
first transmission means for transmitting the data to the other electric devices though said first communication line;
second transmission means for transmitting the data to the other electric devices through said second communication line;
detector means for detecting the shift position instruction input from said operation unit; and
shift position instruction transmission control means which converts the shift position instruction detected by said detector means into a transmission data, and transmits said transmission data from said first transmission means and said second transmission to said other electric devices at a predetermined transmission timing.

41. A shift position control unit used in a communication system for a vehicle drive system according to claim 34, comprising:
first communication means for transmitting and receiving the data through said first communication line;
second communication means for transmitting and receiving the data through said second communication line;
operation means which obtains the data representing the shift position instruction and the operating conditions of the vehicle out of the data received by both or either one of said first communication means and said second communication means, and operates an optimum shift position of the transmission based on said received data; and
shift position change-over means for changing the shift position of said transmission over to an optimum shift position operated by said operation means.

42. A shift position control unit according to claim 41, further comprising:
failure-in-the-communication notifying means which, when the data to be transmitted through both said first communication line and said second communication line are received through either said first communication means or said second communication means, so judges that the communication system has failed on the communication line to which the other communication means is connected, and notifies this fact to an external unit.

43. A shift position control unit according to claim 41, further comprising reliability judging means which, when the same data are received through said first communication means and said second communication means, judges the reliability of the data, and sets the data having higher reliability as the data which said operation means uses for computing said optimum shift position.

44. A shift position control unit according to claim 43, wherein said reliability judging means judges the reliability of the received data relying upon at least one of the period for receiving the data, the continuity of the data content from the data received in the past, and the validity of the data content.

45. A shift position control unit according to claim 41, further comprising second receiver means for receiving the data through said second communication line, wherein said operation means sends a shift position change-over instruction corresponding to the operated result of said optimum shift position to said shift position change-over means and converts said shift position change-over instruction into a transmission data so as to be transmitted from said second communication means onto said second communication line, and said shift position change-over means, during the normal operation, changes over the shift position of said transmission according to said shift position change-over instruction input from said operation means, and changes over the shift position of said transmission according to the shift position change-over instruction received through said second reception means when the data representing said shift position change-over instruction is received through said second reception means.

46. A shift position control unit according to claim 41, further comprising second receiver means for receiving the data through said second communication line, wherein said shift position change-over means monitors the operation state of said operation means and, when the operation of said operation means is faulty, changes over the shift position of said transmission according to the data representing the shift position instruction from said shift position instruction detector unit received by said second communication means.

47. A shift position control unit according to claim 41, wherein said transmission is an automatic transmission, and, when the present shift position of said automatic transmission can be changed, said operation means is so constituted as to compute an optimum gear position of said automatic transmission based upon the data representing the operating condition of the vehicle obtained from the data received through both or either one of said first communication means and said second communication means, and provision is further made of gear position change-over means for changing the gear position of said automatic transmission over to an optimum gear position computed by said operation means.
